(19) United States
(12) Patent Application Publication
(10) Pub. No.: US 2020/0220439 A1
(43) Pub. Date: Jul. 9, 2020

(54) Integrated Adaptive Polyphase Electric Motor

(71) Applicants: Axel Michael Sigmar, Lago Vista, TX (US); Leland Modoc, Lago Vista, TX (US)

(72) Inventors: Axel Michael Sigmar, Lago Vista, TX (US); Leland Modoc, Lago Vista, TX (US)

(21) Appl. No.: 16/379,757

(22) Filed: Apr. 9, 2019

Related U.S. Application Data
(63) Continuation-in-part of application No. 15/859,507, filed on Dec. 30, 2017.
(60) Provisional application No. 62/655,152, filed on Apr. 9, 2018.
(60) Provisional application No. 62/440,984, filed on Dec. 30, 2016.

(51) Int. Cl. H02K 16/02; H02K 3/24; H02K 5/02; H02K 7/20; H02K 9/19; H02K 11/33; H02K 29/03

(52) U.S. Cl. CPC H02K 16/02; H02K 3/24; H02K 5/02; H02K 29/03; H02K 9/19; H02K 11/33; H02K 7/20

(57) ABSTRACT

In some embodiments, a system may include an electrical motor including a cylindrical rotor including an inner circumferential magnetic array and an outer circumferential magnetic array spaced apart by an air gap. The electrical motor may further include a stator including a circumferential array of coils sized to fit within the air gap and a plurality of power electronic circuits. Each power electronic circuit of the plurality of power electronic circuits may independently control current to one or more coils of the circumferential array of coils.

### CROSS-REFERENCE TO RELATED APPLICATION(S)

This application is a non-provisional of and claims priority to U.S. Provisional Patent Application No. 62/655,152 filed on Apr. 9, 2018 and entitled “Integrated Adaptive Polyphase Electric Motor”, which is a continuation in part of and claims priority to co-pending U.S. patent application Ser. No. 15/859,507 filed on Dec. 30, 2017 and entitled “Adaptive Polyphase Motor”, which claims priority to U.S. Provisional Patent Application No. 62/440,984 filed on Dec. 30, 2016 and entitled “Active Series Hybrid Integrated Electric Vehicle”, all of which are incorporated herein by reference in their entireties.

U.S. patent application Ser. No. 16/373,583 (Attorney Docket No. 8050-0005-NP) filed on Apr. 2, 2019 and entitled “Pump Apparatus with Reduced Vibration and Distributed Loading”, which is incorporated herein by reference in its entirety.

### FIELD

The present disclosure is generally related to electric motors, and more particularly to high power, ultra-high torque, low speed, composite, oil-cooled, integrated adaptive polyphase electric motors.

### BACKGROUND

An electric motor is an electromechanical machine that can be used to supply motive power for a vehicle, pump, compressor, propeller shaft or some other device with moving parts. The motor may rotate about an axis or move linearly in more than one direction. Further, an electric motor can be utilized as a generator to convert kinetic energy of a mechanical system into electric potential energy. In some incarnations, both transforms of energy may be utilized. Most electric motors operate via interactions between multiple magnetic circuits whereby magnets, permanent and electromagnet, are arranged specifically to pass through corresponding magnetic circuits at given time intervals. The motors in this arrangement may utilize electric power to generate mechanical power, or utilize external force to generate electric power.

In some examples, electric motors can be used in a variety of devices, including but not limited to, fans, blowers, pumps, machine tools, household appliances, power tools, electric vehicles, other devices, or any combination thereof. Motors can be powered by direct current (DC) power sources, which may include batteries, DC generators, and rectifiers, or by alternating current (AC) sources, such as from the power grid, inverters, generators, or mechanical sources such as internal combustion engines, hydraulic turbines, steam turbines, or any combination thereof. Systems incorporating high power prime movers generally require selectable transmissions operating in concert with reduction gear trains. These gear systems provide the high torque at the low speeds at which loads, such as pumps, compressors, grinders, propellers and some other devices, may operate. The axial length and weight of these prime movers is often exacerbated by the additional length and weight of the gear systems. Efficiency is lost in the reduction train which in turn takes the form of heat, increasing the need for additional lubrication and cooling resources. At each incremental reduction, increases in system and maintenance costs are incurred while reducing system reliability.

In some high power systems, the prime mover operates at high rotational speeds to achieve a high power density, but when the load using this power must operate at range of low rotational speeds, the reduction gear train reaches a number of natural limits which can include bearings, strength of materials or overall system weight, necessitating further system fragmentation, which in turn compounds the losses and introduces control system complexities.

### SUMMARY

Embodiments of the present disclosure may include a lightweight, low speed, high torque electric motor without reduction gears. The electric motor combines novel use of modern power electronics, integrated cooling methods, novel geometric relationships of magnetic, electromagnetic and composite materials, and other features that enable a high torque operation at a wide range of operating speeds that may be useful by the load device, such as a pump. This novel combination may be especially enabling for a number of devices and systems because it can be compact and lightweight so that more power can be delivered to the load within the real constraints of size and weight, such as defined by transportation limits or other system constraints. Further, this is achieved at the same or lower cost as existing systems, with higher reliability, reduced maintenance requirements, and longer life.

Novel geometries holistically conceived for lightweight, high power systems may utilize composite materials to generate, transmit, and react the very high torque of such high power, low speed motors. As compared to conventional alloys; the higher modulus of certain composites may offer stiffness and damping properties, which can contribute to achieving considerably high-power levels in smaller packages. Further, the use of a dual-gap magnetic architecture allows for the use of composite materials as structural elements in permanent magnet motors. In some cases, the advantages of the material properties may be used to simplify load paths and reduce component count by incorporating multiple features, while holding manufacturing tolerances and maintaining deflections under high forces that would not be possible with traditional metal alloys in these enabling novel geometries. Often many aspects of these novel enabling designs are governed by deflections rather than allowable stresses, using the anisotropic properties of the materials to advantage, particularly tensile strength and yield strength and, in some implementations, higher modulus. Design geometries that consider loads in tension in some paths and in compression others can enable the objectives of these embodiments.

Embodiments of the motor described below may include integrated thermal management components. As temperatures vary, tremendous forces are often generated, especially at interfaces between materials having different coefficients of thermal expansion. Further, many advanced composite materials, magnetic materials, and power electronic components have relatively low upper temperature limits compared to metal alloys, so design for heat flow and certain active cooling measures can be important to manufacturing, operation and machine health management, especially at these very high power densities.

To sustain the high-power density in such composite electric motors, oil cooling of the magnetic components and the power electronics may be used. Additionally, passive cooling features can be designed in conjunction with the use of materials that are selectively anisotropically conductive, conducting heat away from the source, providing cooler operating temperatures and enhancing the life cycle of the circuitry and other components.

In some embodiments, an electric motor may include a plurality of magnetic circuits, where each magnetic circuit contains an arrangement of magnetic circuit modules; typically configured as a rotor having a first magnetic array and a second magnetic array extending substantially parallel with one another and spaced apart by a gap. The electric motor may further include a stator including a plurality of modular electromagnet coil assemblies configured to fit between the rotor magnetic arrays and, in response to electrical current, to provide an electromotive force within the gap to accelerate the magnetic arrays. In some embodiments, the stator may include a plurality of individual electromagnetic coil assemblies, each of which may have individual electromagnetic drive circuitry and integrated cooling.

In some implementations, this dual gap structure may dramatically reduce electrical copper losses, inductive losses, and horsepower losses due to coil shorting or failure. The stator configuration allows for a two percent maximum loss of power due to element short or switching malfunction. Further, this arrangement allows the power switching architecture to be located close to the electromagnet, reducing copper losses, inductance, mutual inductance and parasitic cross-talk between active and inactive magnetic elements, and reducing switching loads and noise. Further, each modular electromagnetic coil assembly may include drive circuitry that may be configured to adapt the switching waveform to the load, to the coil's performance, and to other factors.

In some embodiments, the first magnetic array may include a circular array forming a closed magnetic loop. The second magnetic array may include a circular array forming a second closed magnetic loop that fits within the first magnetic array. The coil assembly may include a plurality of electromagnets configured to fit within a gap between the first and second magnetic arrays.

In some implementations, a system may include an electrical motor including a cylindrical rotor including an inner circumferential magnetic array and an outer circumferential magnetic array spaced apart by an air gap. The electrical motor may further include a stator including a circumferential array of coils sized to fit within the air gap and a plurality of power electronic circuits. Each power electronic circuit of the plurality of power electronic circuits may independently control current to one or more coils of the circumferential array of coils.

In other embodiments, a motor may include a shaft defining an axis and a stator. The stator may include a base defining an opening to receive the shaft, a plurality of electromagnetic coils coupled to the base and arranged to form a ring spaced apart from the opening, and power electronics circuitry coupled to the base between the opening and the plurality of electromagnetic coils. The power electronics circuitry may also be spaced apart from the plurality of electromagnetic coils. The power electronics circuitry may control each coil of the plurality of electromagnetic coils independently. The motor may further include a rotor including an opening to couple to the shaft. The rotor may include an inner magnetic array arranged in a first circle, and an outer magnetic array arranged in a second circle that is larger than and spaced apart from the first circle defining an air gap sized to receive the plurality of electromagnetic coils.

In still other embodiments, a motor may include a rotor and a stator. The rotor may include a housing coupled to a shaft defining an axis of rotation, a first magnetic array arranged to form an inner ring within the housing, and a second magnetic array arranged to form an outer ring within the housing and spaced apart from the first magnetic array by an air gap. The stator may include a base defining an opening sized to fit over the shaft and a plurality of electromagnetic coils coupled to the base and arranged to form a ring such that the ring fits within the air gap. The motor may further include a plurality of power electronic circuits coupled to the base. The plurality of power electronic circuits may be spaced apart from the plurality of electromagnetic coils, and positioned between the plurality of electromagnetic coils and the opening. Each of the plurality of power electronic circuits may control one or more of the coils of the plurality of electromagnetic coils.

### BRIEF DESCRIPTION OF THE DRAWINGS

FIG. 1 depicts a block diagram of a system including a control system coupled to a motor, in accordance with certain embodiments of the present disclosure.

FIG. 2 depicts a sectional exploded view of the electric motor of FIG. 1, in accordance with certain embodiments of the present disclosure.

FIG. 3 depicts a view of a portion of the motor of FIG. 2 including a magnetic circuit array having the rotor with inner and outer magnetic arrays and including a plurality of coils of the stator assembly, in accordance with certain embodiments of the present disclosure.

FIG. 4 depicts a view of magnetic fields produced by the portion of the motor of FIG. 3 showing that the magnetic field lines are contained by the inner and outer magnetic arrays, in accordance with certain embodiments of the present disclosure.

FIG. 5 depicts a perspective view of the stator of the motor of FIGS. 1-4 with one modular electromagnetic coil separated from the array, in accordance with certain embodiments of the present disclosure.

FIG. 6 depicts a section view of the stator of FIG. 5, in accordance with certain embodiments of the present disclosure.

FIG. 7 depicts a top view of a portion of the motor of FIGS. 1-6 depicting field vectors extending between inner and outer magnet arrays through stator coils positioned between the arrays, in accordance with certain embodiments of the present disclosure.

FIG. 8 depicts a top view of a portion of the motor of FIGS. 1-7 depicting magnetic field vectors and curvature of the arrays and the stator, in accordance with certain embodiments of the present disclosure.

FIG. 9 depicts a portion of the motor of FIGS. 1-8 including portions of the inner and outer magnetic arrays and the stator, in accordance with certain embodiments of the present disclosure.

FIG. 10A depicts a portion of the motor of FIGS. 1-8 rearranged as an array, in accordance with certain embodiments of the present disclosure.

FIG. 10B depicts a cross-sectional view of the array taken along line B-B in FIG. 10A.

FIG. 10C depicts a cross-sectional view of a magnetic coil assembly taken along line C-C in FIG. 10B.

FIG. 11 depicts a system including a circuit configured to drive a magnetic coil assembly of the motor of FIGS. 1-10C, in accordance with certain embodiments of the present disclosure.

FIG. 12 depicts a simplified diagram of an independent winding motor control, in accordance with certain embodiments of the present disclosure.

FIG. 13 depicts an exploded view of motor assembly, in accordance with certain embodiments of the present disclosure.

FIG. 14 depicts a front view of the motor assembly of FIG. 13, in accordance with certain embodiments of the present disclosure.

FIG. 15 depicts a cross-sectional view (axially cut) of the motor assembly, in accordance with certain embodiments of the present disclosure.

FIG. 16 depicts a diagram of a motor magnetic circuit, in accordance with certain embodiments of the present disclosure.

FIG. 17 depicts a four motor and pump combination on common shaft, in accordance with certain embodiments of the present disclosure.

FIG. 18 depicts an exploded view of a motor stator assembly, in accordance with certain embodiments of the present disclosure.

FIG. 19 depicts an exploded view of a motor rotor assembly, in accordance with certain embodiments of the present disclosure.

FIG. 20 depicts a diagram of a stator electromagnetic array with one element separated for clarity, in accordance with certain embodiments of the present disclosure.

FIG. 21 depicts an exploded view of an electromagnet array element, in accordance with certain embodiments of the present disclosure.

FIG. 22 depicts an electromagnet array element, in accordance with certain embodiments of the present disclosure.

FIG. 23 depicts a stator electromagnet array with associated power electronics wedge assemblies, in accordance with certain embodiments of the present disclosure.

FIG. 24 depicts stator power electronics wedge connected to coils and electromagnetic element assembly, in accordance with certain embodiments of the present disclosure.

FIG. 25 depicts a power electronics wedge assembly with protective cover removed for clarity, in accordance with certain embodiments of the present disclosure.

FIG. 26 depicts an exploded view of power electronic wedge assembly with protective cover removed for clarity, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

In the following detailed description of embodiments, reference is made to the accompanying drawings which form a part hereof, and which are shown by way of illustrations. It is to be understood that features of various described embodiments may be combined, other embodiments may be utilized, and structural changes may be made without departing from the scope of the present disclosure. It is also to be understood that features of the various embodiments and examples herein can be combined, exchanged, or removed without departing from the scope of the present disclosure.

In accordance with various embodiments, some of the methods and functions described herein may be implemented as one or more software programs running on a computer processor or controller, which may be configured to interact with various devices, for example to control their operations. In certain embodiments, such a processor or controller may be a component of a computing device, such as a tablet computer, a smartphone, a personal computer, a server, a dedicated integrated computing device, or any combination thereof. Dedicated hardware implementations including, but not limited to, application specific integrated circuits, programmable logic arrays, dedicated microprocessor and coprocessor devices designed to provide field control and related functions, and other hardware devices can likewise be constructed to implement the methods and functions described herein. A layered hierarchical architecture of computational, control and communication devices may be included proximate to the assemblies that they sense and control, both individually and in combination, to achieve the combinatorial behavior desired on varying dynamic timeframes and spatial relationships, including manufacturing and thermal variations that limit performance, life and reliability. Further, at least some of the methods described herein may be implemented as a device, such as a computer readable storage device or memory device, including instructions that when executed cause a processor to perform the methods.

Embodiments of systems and apparatuses are described below that include a motor having a rotor and a stator assembly configured to provide motive force in response to electrical currents supplied to the electromagnetic coils (electromagnets) of the stator assembly. The motor represents a direct drive, high torque, efficient, high power density, lightweight electrical machine design that can be implemented in a variety of contexts to drive a plurality of applications. The motor represents a new class of motor (and generator or alternator) based on a confluence of geometries, materials, manufacturing processes, power electronics, cooling methods, and control thereof.

The motor may include an array of independent magnetic circuits, which can be controlled independently to provide an adaptive polyphase motor. Each coil of the stator assembly may be physically close to its own drive electronics, which enhances fast switching and low-loss energy recovery and reuse. In general, efficient fast switching improves (or even maximizes) the useful energy or work done within the electrical cycle of each coil as the magnet passes by, transferring energy between the dual air gaps (provided between the stator coil and the permanent magnets of an inner magnetic array and an outer magnetic array). In some embodiments, the drive electronics may include diodes, resistors, inductors, and capacitors directly associated with each coil (as part of or in addition to a snubber circuit), which can reduce (or even minimize) the inherent (or parasitic) losses and electrical noise, which generate heat and subtract from the overall efficiency of the motor. Transient currents and voltages can be carefully managed for each coil assembly. This can be a significant improvement over conventional compromises made in three, six, or other such variants of conventionally phased motors.

Embodiments of a motor are described below that may include a stator including a plurality of coils and a rotor including an inner magnetic array and an outer magnetic array, which arrays are formed from plurality of permanent magnets. The permanent magnets may be formed from a plurality of segmented magnets of the same size, composition, and magnetic properties, which magnets may be arranged and wrapped or coated to provide a desired magnetic field arrangement with little or no magnetic field line leakage.

In general, the concentrated magnetic field provides significant advantages. First, significant torque (circumferential magnetic motive force) increase is achieved and overall weight reduction can be attained. The coils may be formed from a stator hoop on-plate configuration. The rotors include dual magnetic arrays (also hoop-on-plate) formed from segmented magnetic arrays of permanent magnets, which complete a magnetic circuit on both sides of each stator coil without back iron, reducing weight (rotational inertia), reducing eddy current losses, and significantly reducing or eliminating field line leakage external to the working volume. The reduced weight enhances the balance of the motor and substantially reduces large radial forces usually exerted on the stator hoop. Further, the design and arrangement of the segmented magnetic array on both sides of the stator coils operates to confine the magnetic field, obviating the currents induced by stray magnetic fields, which could otherwise operate to heat and weaken structural materials. Further, the confinement of the fields enables the use of non-ferromagnetic materials as structural components, which allows for selection of lighter composite materials, reducing weight, reducing heat retention and further removing the bearing current problems that plague conventional electric machines.

The switching circuitry and the coils may be cooled by the localized integration of thermally conductive electrical insulators, which are not affected by eddy current losses. Further, the magnetic arrays may be thermally balanced with pyrolytic graphite (isotopically thermally very conductive material that is compatible with carbon fiber composite structures). Further, the motor components can be further shielded by magnetically and thermally conductive magnetic shields. Magnetic shielding materials such as Mu-metal, a nickel—iron soft ferromagnetic alloy with very high permeability, can be used for shielding sensitive electronic equipment against static or low-frequency magnetic fields. In composite structures, diamagnetic materials such as pyrolytic graphite can be incorporated to assist in structural support, magnetic containment and spreading of localized heating. The diamagnetic materials may aid in effective removal of heat generated within the magnet arrays. These diamagnetic materials have coefficients of thermal expansion, matrix binding compounds, and manufacturing properties that may be much more compatible than traditional Mu metals. The magnetic shields can be electrically grounded (special bearing considerations), which, in conjunction with similar precautions in the stator plate, electronics housings, and conductor shielding, can result in virtually no externally detectable magnetic signature. The absence of the magnetic signature may be desirable in submarines and advanced minesweeping vessels and vehicles. In certain embodiments, a conductive mesh may be incorporated into the composite structure of the motor components to further contain or shield against electro-magnetic interference. The mesh may be compatible with composite materials without being rejected as a foreign body leading to delamination.

In certain embodiments, the magnetic arrays contain almost all of the magnetic field from the permanent and electromagnets. Further, power density (in kW/kg and kW/liter terms) is enhanced because sources of losses are minimized, remaining loss heat is actively removed, and lightweight materials are able to be utilized due to the advantageous compact geometry and manufacturable modular design of these electrical machines.

In some embodiments, a control system may interact with drive electronics circuitry for each coil to control and monitor each coil independently. In some embodiments, the control system may selectively activate some, but not all, of the coils to allow for segmented, individual actuation. In some embodiments, the addition of a number of sets or “pole pairs” of inner and outer magnetic sources can be added to abate the magnetic alignment or “magnetic locking” of a rotating assembly or rotor. Further configurations may be utilized to match the modal requirements of the accompanied loads in the effected system. The control system may control the electromagnets asynchronously as desired to drive the rotation, or to manage cogging and torque variations occurring in the motor or the load. Further, the electromagnets may be controlled using a plurality of different phases of a periodic signal, such as a square wave or a sinusoidal signal. Further non-regular/non-periodic waveforms may be computed and utilized to achieve performance or efficiency goals as calculated by the control system for the specified position and time. It should be appreciated that each of the modular coils may be controlled independently of the other coils, and the waveforms may be customized to each coil to achieve selected performance, efficiency, or extended life and reliability goals.

In some embodiments, the electromagnets may be driven by a selected number of signals, where the number of signals may be selectively controlled and dynamically changed or augmented to achieve a desired motive force. A control circuit or system may be configured to control the signals to drive the electromagnets via the drive electronics of each coil. Further, the control circuit may selectively activate some, but not all, of the electromagnets at selected phases/pulses. For example, to reduce power consumption, once the rotor is moving at a selected speed, the control circuit may selectively disable or partially disable some of the electromagnets and selectively drive other electromagnets to maintain the selected speed, while reducing overall power consumption. In some implementations, maximum performance may be achieved within carefully managed thermal constraints, which may vary with each coil or drive electronic package. Further, in some embodiments, parameters may be managed to enhance available power and to manage the life of the motor. Other embodiments are also possible.

In some embodiments, the motor may include a plurality of magnetic circuit modules, each of which may include an inner magnetic source, a central magnetic source, and an outer magnetic source. The central magnetic source may be coupled to a stationary reference or stator, which is configured to drive a rotating reference frame or rotor that includes the inner and outer magnetic sources. The magnetic sources may be permanent, electromagnetic, or any combination thereof. The magnetic sources may be arranged in a variety of arrays. In some embodiments, the magnetic poles of the inner magnetic sources may be offset by up to one-half of a pole pitch relative to the outer magnetic sources. In some embodiments, the magnetic pole alignment of the central magnetic source may be as close to parallel to a center line between the inner magnetic source and the outer magnetic source. When the inner and outer magnetic sources are arranged in circular arrays, the pole alignment can be parallel to a tangent line of the circular arrays at a center point of the central magnetic source.

In some embodiments, a motor may include a rotor having an inner circumferential array of magnets and an outer circumferential array of magnets separated by an air gap defining a channel. The motor may further include a stator assembly including a plurality of magnetic sources configured to fit within the channel. In some embodiments, the rotor is configured to rotate relative to the stator in response to magnetic fields presented by the magnetic sources of the stator assembly. Other embodiments are also possible.

In some embodiments, the magnetic sources of the stator assembly may be electromagnetic and may be controlled by a control circuit to drive the rotor. The magnetic coils of the stator may consume power according to the back electromotive force as well as the resistance and inductance provided by the magnetic coil. The control circuit may drive the stator using direct current (DC) power, but the time-varying nature of the current leaving the coil implicates fringing and skin depth related issues with respect to the surface area of the conductor. By utilizing an insulated gate bipolar transistor (IGBT) or other insulated circuit for switching, the current from the coil may be selectively directed onto a power bus, which can have a large surface area. The circuitry may be mounted to the stator and immersed in oil, such as a mineral or silicone-based oil, for cooling. Further, in some embodiments, the stator coils may be turned horizontally and the core of the coils may be driven into partial magnetic saturation to enhance the motive force applied to the rotor.

In one possible implementation, a system may be comprised of one or more electrical motors. Each electric motor may include a stator and a coil assembly comprising a plurality of modular coils. The stator may include a multi-array magnet configuration with a gap or channel defined between the arrays. The stator may be formed from light-weight composite materials having a high modulus, high resonant frequency, and large diameter. Thus, the stator may have a reduced weight and may have lower costs as compared to conventional electric motors. The plurality of modular coils may be sized to fit within the gap or channel, such that the coils are separated from a first array by a first air gap and from the second array by a second air gap on opposite sides of the coils.

In some implementations, the array of electromagnets may be wrapped by a magnetically transparent electrical insulator, such as Mylar. Each coil may include a large coil count and may include connectors to electrically, mechanically, and thermally couple the coil to circuitry of the coil assembly. The coil assembly may include a plurality of wedges, where each wedge drives one or more modular coils and contains a circuit including integrated power electronics to independently control each of the coils.

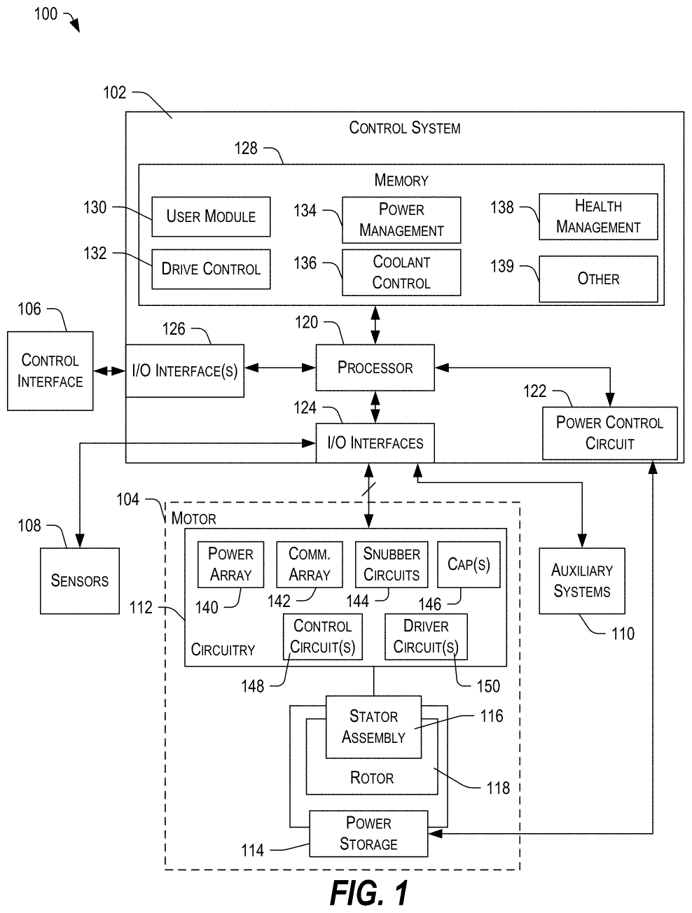

Further, a system including one or more motors may include a plurality of control circuits and a control system configured to provide control signals to each of the plurality of control circuits. One possible implementation of a system including such a motor is described below with respect to FIG. 1.

FIG. 1 depicts a block diagram of a system 100 including a control system 102 coupled to a motor 104, in accordance with certain embodiments of the present disclosure. The control system 102 may be coupled to a control interface 106. The control interface 106 may include a keyboard, a display, a stylus, a pointer, another device, or any combination thereof Alternatively, the control interface 106 may include or be coupled to various mechanical inputs, such as a steering wheel or other electro-mechanical controls. Further, the control system 102 may be coupled to one or more sensors 108, one or more auxiliary systems 110, and one or more power control circuits 112, which may be integrated within or coupled to the electrical motor 104. The system 100 may further include power storage 114, such as a plurality of capacitors or rechargeable batteries, which may be coupled to the control system 102 and to the motor 104.

In some embodiments, the motor 104 may include a stator assembly 116 arranged relative to a rotor 118, which may be configured to rotate relative to the stator assembly 116. The stator assembly 116 may be bolted or otherwise attached to a housing of the motor 104, so that the motive force created by the stator coils may cause the rotor 118 to rotate about an axis. The rotor 118 may include dual magnetic arrays separated by an air gap defining a channel, and stator 116 may be comprised of a plurality of modular coils which may be sized to fit within the channel.

The stator assembly 116 may include a plurality of wedges. Each wedge may include one or more modular coils and power electronics to control each of the one or more modular coils independently. The independent control of each coil allows for customization of drive signals to each coil to improve performance of the motor.

The motor 104 may include circuitry 112 coupled to the control system 102 through the I/O interfaces 124. The circuitry 112 can include a power array 140 configured to deliver power from the control system 102 (or from a power storage device controlled by or associated with an overall system) to other circuits and to the stator assembly 116. The circuitry 112 can further include a communications array circuit 142 configured to facilitate communication of sensor data (from sensors 108, for example) and control signals between the motor 114 and the control system 102.

The circuitry 112 may further include capacitors 146 and snubber circuits 144. It should be appreciated that each coil of the stator assembly 116 may include a snubber circuit 144 and capacitors 146 to suppress current and voltage spikes from switching the current through the coils of the stator assembly and to reuse at least some of the voltage to recharge the coil or to reverse current flow through the coil during switching. In some examples, the capacitors 146 may be part of the snubber circuits 144.

Further, the circuitry 112 may include a plurality of control circuits 148, where each control circuit 148 is associated with one or more coils of the plurality of coils of the stator. The control circuits 148 may be configured to communicate with one another and to cooperate with one another to provide thermal management and to control operation of one or more driver circuits 150. Each driver circuit 150 may be coupled to at least one of the modular stator coils. This enables the capability of providing a unique drive signal waveform to each modular stator coil independently to provide a desired functionality.

In some embodiments, the control system 102 may be configured to control operation of the one or more motors, by communicating with the circuitry of the motor 112. The control system 102 may include a processor 120 coupled to a power control system 122, which may be coupled to the power storage 114 to control delivery of power to the motor 104 and to the control system 102. The control system 102 may further include one or more input/output (I/O) interfaces 124 coupled to the processor 120 and configured to couple to the circuitry 112 of the motor 104. In some embodiments, the processor 120 may control switches and other circuitry within the motor 104 to control operation of the motor 104 by sending control signals through the one or more I/O interfaces 124.

The control system 102 may further include I/O interfaces 126 coupled to the processor 120 and configured to couple to the control interface 106 to receive input, such as from a user. The control interface 106 may include a keyboard, a display, a stylus, a pointer, another device, or any combination thereof. In some implementations, the control interface 106 may include one or more transceivers configured to communicate with a network or to communicate wirelessly with a computing device, such as tablet or laptop computer or a smartphone through a short range wireless communications link, such as a Bluetooth communications link. In other implementations, the control interface 106 may be coupled to electro-mechanical devices, such as mechanical elements. The control system 102 may further include a memory 128 coupled to the processor 120. The memory 128 may be configured to store data and to store instructions that may, when executed, cause the processor 120 to perform a variety of operations. It should be understood that the memory 128 may include volatile memory, such as cache memory, and non-volatile memory, such as flash memory, hard disc devices, hybrid memory devices, or any combination thereof.

In the illustrated example, the memory 128 may include a user module 130 that, when executed, may cause the processor 120 to receive data from the control interface 106. In an example, the control interface 106 can include a steering input, an acceleration input, a braking input, or other input. In another example, the control interface 106 can include a pressure input (such as for maintenance of a fluid pressure in a drilling context) or another input mechanism that can provide data for use by the control system 102 for controlling operation of the motor 104. Other embodiments are also possible.

The memory 128 may further include drive control instructions 132 that, when executed, may cause the processor 120 to generate control signals automatically or in response to signals from the control interface 106 and to provide the control signals to the motor 104 through the I/O interfaces 124. In some embodiments, the control signals may cause the stator assembly 116 to selectively activate the coils. In a particular example, the control signals may be received by the control circuits 148, which may control operation of the driver circuits 150 to provide selected wave forms, such as periodic signals, which may be selectively applied to one or more of the coils, independently. It should be appreciated that the output signals from the driver circuits 150 may include periodic waveforms, such as sinusoidal wave forms (sine waves, square waves, triangular waves, and so on), aperiodic waveforms, customized waveforms, and so on. In certain examples, the drive circuitry 150 may provide a selected waveform to each modular coil independently to achieve desired performance parameters. In some embodiments, the drive control instructions may cause the processor 120 to drive the coils asynchronously and with any number of phases. Other embodiments are also possible.

The memory 128 may also include a power management module 134 that, when executed, may cause the processor 120 to generate control signals to control the delivery of DC power from the power storage 114 by sending the control signals to the power control circuit 122, which then controls the power storage 114. The memory 128 may also include a coolant control module 136 that, when executed, may cause the processor 120 to generate coolant control signals and to provide the coolant control signals to the motor 104 to control a coolant pump or other element of the motor 104 to provide cooling for the stator assembly 116.

The memory 128 may include health management instructions 138 that cause the processor 120 to monitor temperature, currents, voltages, performance, and other parameters of each of the coils of the stator 116 as well as parameters of the motor 104. In some implementations, the health management instructions 138 may cause the processor 120 to send control signals to one or more power control electronics wedges within the motor 104 to selectively adjust performance and operation of one or more elements of the motor 104. In some implementations, adjustments can be made based on temperature or other parameters determined by the sensors 108 to protect components of the motor 104 and to optimize the life of the motor 104 and its components. Other implementations are also possible.

The health management instructions 138 may communicate with control circuits 148 within the motor 104 to manage various parameters, which may enhance performance, including efficiency, power yield, and so on. Further, the health management instructions 138 may communicate with the control circuits 148 to determine various parameters associated with one or more of the stator coils, circuits, capacitors, batteries, or other components. Further, the determined parameters may be used by the control circuits 148, the health management instructions 138, or both to adjust one or more coefficients or operating parameters to enhance the life of the motor 104. For example, the health management instructions 138 or the control circuits 148 may reduce current to a particular coil that is overheating, distributing the load to other coils. In another example, the health management instructions 138 or the control circuits 148 may reduce or eliminating overheating, overloading, and so on, improving the life of components of the motor 104. In certain implementations, the health management instructions 138 or the control circuits 148 may shut down operation to prevent a failure event. Other implementations are also possible.

The memory 128 may further include other instructions 139 that, when executed, may cause the processor 120 to perform other operations, such as providing feedback to the control interface 106. Other embodiments are also possible.

In some embodiments, the system 100 may be configured to provide motive force by applying control signals to the circuitry 112 through the communications array 142 to drive the movement of the rotor 118. The geometry of the rotor assembly 118. In some embodiments, the system 100 may receive signals from the one or more sensors 108 and may selectively control operation of the motor 104, at least in part, based on the signals from the sensors 108. In some embodiments, the sensors 108 may include temperature sensors, rotational speed sensors, pressure sensors, other sensors, or any combination thereof. In some embodiments, the sensors 108 may be included within the motor 104.

In some embodiments, the circuitry 112 may be duplicated for each coil of the plurality of coils of the stator assembly 116, allowing for independent control and independent energy storage for each coil. This allows for unprecedented machine flexibility in terms of adjustable resolution on a per coil basis to increase the efficiency, performance and life of each of the coils and for each wedge.

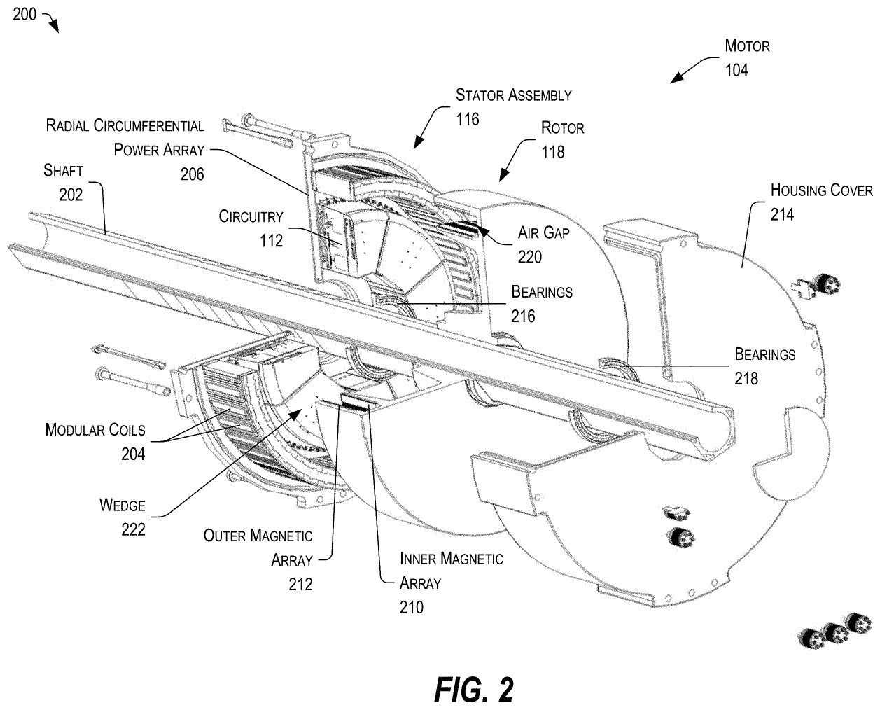

FIG. 2 depicts an exploded sectional view of the electric motor 104 of FIG. 1, in accordance with certain embodiments of the present disclosure. The motor 104 may include a stator assembly 116 and a rotor 118. The motor 104 may include a shaft 202, which may extend through an opening of the stator assembly 116 and which may be coupled to the rotor 118 so that the rotational movement of the rotor 118 may turn the shaft 202. The shaft 202 may define an axis about which the shaft 202 rotates and about which the rotor 118 turns. In some embodiments, at least a portion of the stator assembly 116, the rotor assembly 118, and a housing cover 214 may be formed from carbon fiber or other composite materials.

The stator assembly 116 may be bolted to or incorporated in a frame or housing of a structure, such as a frame of a vehicle, a housing of a pump, or some other structure, so that the electromagnetic force can cause the rotor 118 to turn relative to the stator assembly 116 and the structure. The stator assembly 116 may include a plurality of modular coils 204, each of which may include a wire coil wrapped around a laminate core. In some implementations, the core may be formed from or contained by Mylar or another composite material. The stator assembly 116 may be coupled to circuitry 112 and to one or more power sources (such as batteries) through a radial circumferential power array 206, which may be electrically coupled to the coil assemblies 204 and to circuitry 112, which may include a plurality insulated gate bipolar transistors (IGBTs) to provide integrated switching to provide high efficiency and fast switching between the ends of the coils 204 and the snubber circuit and capacitors. In other implementations, other power electronic modules of Silicon carbide (SiC) or other materials may be substituted for IGBTs to provide similar functionality. The circuitry 112 may include integrated cooling as well as a snubber circuit of inductors, capacitors, and in some cases other active devices for temporary storage of energy during current switching operations in order to recover and reuse power from the coils 204 and without having to deliver the power to an external circuit, eliminate over-voltages and otherwise minimize voltage stresses and losses.

The motor 104 may further include the rotor 116, which includes an inner magnetic array 210 and an outer magnetic array 212 spaced apart by an air gap that defines a channel sized to receive the electromagnetic coils 204 of the stator 116. The magnets of the magnet arrays 210 and 212 may be configured in an array where the magnets are arranged to provide a spatially rotating pattern of magnetization. The permanent magnets of the arrays 210 and 212 can provide a magnetic flux distribution that interacts with the magnetic fields produced by current flowing through the coils 204 of the stator assembly 116. The interaction between the magnetic flux distribution and the induced magnetic fields may accelerate the rotor 118 rotationally about an axis corresponding to the axis of the crank shaft 202.

The motor 104 may further include a housing cover 214, which may couple to a substrate of a stator assembly 116 to form a sealed enclosure. In some embodiments, the stator assembly 116, the coils 204, the circuitry 112 (including capacitors and snubber circuits), and the cooling assembly may be sealed within the enclosure, which may be filled with an oil to facilitate cooling of the circuitry. In some embodiments, the oil may be circulated using a pump or other controllable device to facilitate cooling of the components. Further, in the illustrated example, bearings 216 and 218 are depicted. Other components may also be included, which are omitted here for ease of illustration and discussion.

In some embodiments, the magnetic arrays 210 and 212 may be formed by a plurality of small magnets, which may be coated to facilitate magnetic field containment and which may be interconnected and arranged to direct magnetic field lines to remain within the periphery of the arrays 210 and 212. By containing the magnetic fields with the working volume, external structures for further containment of the magnetic fields may be omitted. Further, the arrays 210 and 212 are separated by an air gap 220 sized to receive the modular coils 204 such that the rotor 118 can turn relative to the stator assembly 116. It should be appreciated that each modular coil 204 may be separated from the inner magnetic array 210 by a first air gap and from the outer magnetic array 212 by a second air gap.

It should be appreciated that the stator assembly 116 may be formed of a plurality of wedges 222. Each wedge 222 may include one or more modular coils 204 and associated circuitry 112, which may be configured to control each of the modular coils 204, independently. In some implementations, each wedge 222 may include circuitry 112, batteries, switches, and other circuitry. The number of wedges 222 and the number of modular coils 204 per wedge 222 may be selected to provide a desired granularity with respect to control of the motor 104. Other implementations are also possible.

In some embodiments, the housing cover 214, for example, may be formed from plastic, Teflon, a different composite material, or any combination thereof. The ability to use other materials allows the motor to be formed from a relatively light structural material, reducing weight loads and making it easier to turn the rotor 118. Moreover, the lighter material can reduce heat retention and provide for a more efficient motor design. Other embodiments are also possible.

The motor 104 is implemented as a direct drive, high torque, efficient, high power density, lightweight electric machine design that can be designed to enable many applications, including motors, actuators, pumps, generators, other systems, or any combination thereof. A new class of motor and generator or alternator is also possible from the confluence of geometries, materials, manufacturing processes, power electronics and control thereof, which are described herein.

Each coil of the stator 116 of this adaptive, polyphase motor 104 is close to its own drive electronics or circuitry 112. Efficient fast switching of the current into and out from the coils 204 maximizes the useful energy or work done in the electrical cycle of each coil 204 as the magnet passes by, transferring energy between the dual airgaps (between the coil 204 and the inner magnet array 210 and the outer magnet array 212). The circuitry 112 may include inductors and capacitors (as part of or in addition to a snubber circuit) directly associated with each coil 204. During switching, power from the coil 204 may be stored in a capacitor (and/or snubber circuit) close to the coil 204, reducing the inherent (parasitic) losses and acoustic noise, which generate heat and subtract from the overall efficiency of the motor 104. This reduction in losses and heating can provide a significant improvement in motor architectures, particular as the number of phases of the motor increases.

The motor 104 provides significant torque (circumferential magnetic motive force) increases and weight reduction. In particular, the stator assembly 116 is a hoop-on-plate configuration, which interfaces with dual rotors 118 (also hoop-on-plate) comprised of segmented magnetic arrays (such as Halbach arrays) of permanent magnets. The magnetic arrays 210 and 212 cooperate to complete the magnetic circuit on both sides of the stator coil 204 without back iron, reducing weight (rotational inertia) and eddy current losses. The omission of back iron allows for lighter materials and improved balance of the system, substantially reducing the large radial forces usually exerted on the stator hoop assembly 116.

The segmented magnetic arrays 210 and 212 confine the magnetic field, obviating the currents induced by stray magnetic fields, which otherwise heat and weaken structural materials and reduce overall efficiency. The magnetic arrays 210 and 212 contain almost all of the magnetic field from the permanent and electromagnets. The motor 104 can be further shielded as necessary by magnetically and thermally conductive mu-metal shields or diamagnetic materials such as pyrolytic graphite and composite compatible conductive mesh materials. The mu-metal may include a nickel—iron soft ferromagnetic alloy with very high permeability, which can used for shielding sensitive electronic equipment against static or low frequency magnetic fields. The mu shields may be electrically grounded. The stator plate of the stator 116, electronics housings and conductor shielding can result in virtually no detectable magnetic signature, which may be desirable in magnetically sensitive applications, such as in submarines and advanced minesweeping vessels and vehicles.

In some implementations, cooling circuitry may be included in circuitry 112. The cooling circuitry can include an integrated pyrolytic graphite (anisotropically, thermally very conductive material that is compatible with carbon fiber composite structures). In some implementations, pyrolytic graphite and cooling slots may be incorporated in the laminate core of the coil assembly. Other cooling techniques and other components may also be used, including thermal oil cooling and other cooling techniques.

The motor 104 enhances the overall power density (in kW/kg and KW/liter terms) because all sources of losses are minimized, remaining loss heat is actively removed, and lightweight materials are able to be utilized due to the advantageous compact geometry and manufacturable modular design of the motor 104. Further, load paths from the stator assembly 116 to the stator plate to the outer motor housing cover 214 and onward to the load are short, direct and take full advantage of large diameters and high material modulus, resulting in a compact, stiff, quiet machine that is easily coupled to the load.

Machine health management (superior to monitoring) is enabled by monitoring temperatures and electrical characteristics along with baselines in each coil and power electronics unit at each coil individually. Further, performance (torque at desired Revolutions per Minute (RPM)) can be maximized within limits of machine health management on a continuous or burst mode basis, within each coil and power electronics unit. Normally efficiency can be maximized to minimize losses and heat generated at the desired power. Further, each coil 204 can be controlled independently to provide a desired performance and efficiency. Instantaneous or short duration torque bursts can be desirable and are possible within the thermal inertia of the cooling system, because of the sensing and control inherent in the machine health management incorporated in the distributed motor controllers. Moreover, load can be managed within the coil architecture to alleviate stress on components before they are overwhelmed by thermal inertia.

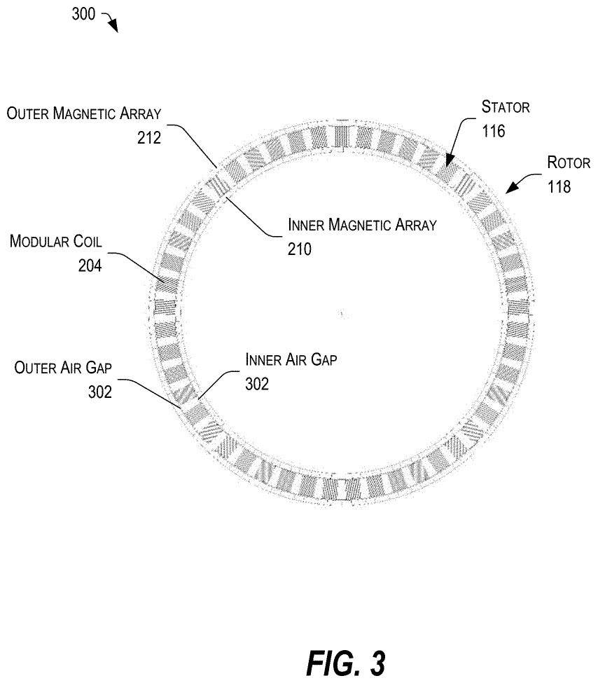

FIG. 3 depicts a view of a portion of the motor of FIGS. 1-2 including a magnetic circuit array 300 that includes the rotor 118 with inner and outer magnetic arrays 210 and 212 and that includes a portion of the stator assembly 116, in accordance with certain embodiments of the present disclosure. In the illustrated example, a magnetic circuit array 300 may include an inner magnetic source including the inner magnetic array 210. The magnetic circuit array 300 may further include an outer magnetic source including the outer magnetic array 212. The magnetic circuit array 300 may also include a plurality of coils 204 of the coil assembly 116. Each coil 204 may include an electrically conductive wire or sheet wound around a laminate core.

In some embodiments, the laminate core may extend substantially parallel to the inner and outer magnetic arrays 210 and 212. The wires that wrap around the cores form the coil assemblies 204 may be wrapped around the laminate core such that the north/south poles of the coil assemblies 204 extend substantially parallel to the tangents of the inner and outer magnetic arrays 210 and 212 through the core.

In the illustrated example, the permanent magnets that form the inner array 210 and the outer array 212 may be formed from a plurality of magnets, each of which may have approximately the same size, the same material composition, and the same magnetic parameters. In some embodiments, the plurality of magnets can be small rectangular or cylindrical magnets. By utilizing the same or similar groups of small size magnets for all of the array magnets, the costs may be reduced because the component magnets can be purchased in bulk, thereby reducing supply costs. Moreover, the smaller magnets can be coupled to one another and arranged to provide the desired magnetic fields. Smaller magnets have better performance and longer life, and they are less expensive to manufacture and easier to assemble.

It should be appreciated that the air gap 220 in FIG. 2 is represented in FIG. 3 as a very small gaps (inner air gap 302 and outer air gap 304) on either side of the stator coils 204. The dual gap structure allows for the use of composite materials in the stator 116 and rotor 118. In some implementations, the dual gap structure may increase the torque of the system by as much as 40% relative to conventional electric motors. Further, segmenting the dual gap into large element arrays may also increase the torque.

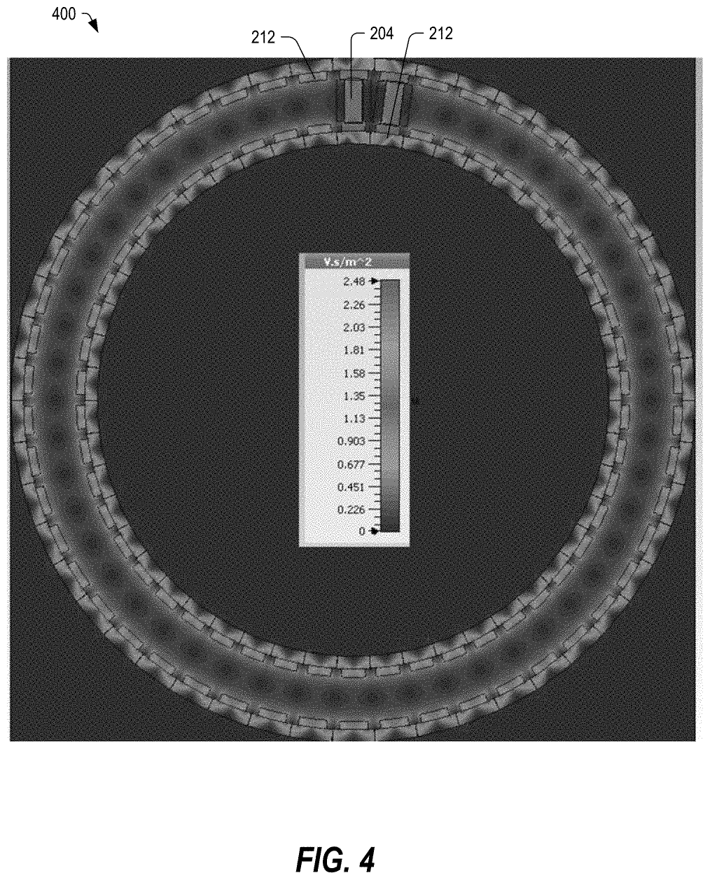

FIG. 4 depicts a graphical view 400 of magnetic fields produced by the motor (stator 116 and rotor 118) of FIGS. 1-3 showing that the magnetic field lines are contained by the inner and outer magnetic arrays 210 and 212, in accordance with certain embodiments of the present disclosure. The view 400 includes the inner magnet array 210, the outer magnet array 212, and stator coils 204. In the illustrated example, the magnetic field is depicted as approximately zero both inside the periphery of the inner magnetic array 210 and outside the periphery of the outer magnetic array 212. The absence of field lines outside of the magnetic arrays 210 and 212 indicates that there is no loss of efficiency from the magnetic fields leaking outside of the arrays 210 and 212.

Further, it should be appreciated that the complete containment of the magnetic field lines within the arrays 210 and 212 provides a significant structural advantage over conventional magnetic arrays. In particular, since magnetic field lines typically leak out, shielding materials are typically used to prevent magnetic interference. Such materials are often heavy and expensive. Since the magnetic fields do not extend beyond the periphery of the arrays 210 and 212 in the embodiments disclosed herein, the external covers for the arrays 210 and 212 may be formed from relatively light-weight materials, such as plastics, composite materials, ceramics, other materials, and the like, without concern for magnetic interference with nearby circuits or structures.

Additionally, since the magnetic field lines are contained by the array, non-ferromagnetic structural elements may be used, which encourages the use of specialized structural materials and which can dramatically reduce the machine weight. Moreover, the containment of the fields may reduce non-working copper losses by a factor of two or more. Further, the containment of the fields may dramatically reduce volumetric frequency dependent losses, because the magnetic fields are isolated into the working volume gap.

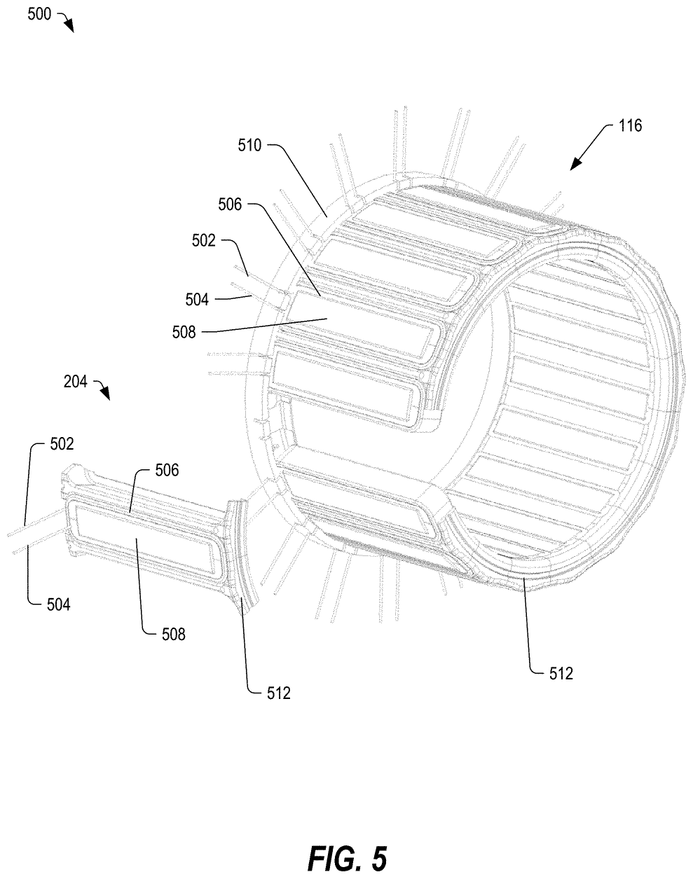

FIG. 5 depicts a perspective view 500 of the stator assembly 116 of the motor of FIGS. 1-4, in accordance with certain embodiments of the present disclosure. The stator assembly 116 may include a base 510 coupled to a plurality of stator coils 204. The base 510 may include one or more connection interfaces to secure a proximal end of each modular coils 204 to the base 510. Further, the stator assembly 116 may include a ring or hoop 512 to secure the distal ends of each of the modular coils 204 to one another in a circumferential configuration.

Each stator coil 204 may include a wire or coil 506 wrapped around a laminate core 508. The wire or coil 506 may include an input 502 and an output 504 coupled to a control circuit (such as the circuitry 112 in FIG. 1).

The stator assembly 116 may include a plurality of stator coils 204 arranged circumferentially about a center axis. The inner magnet array 210 and the outer magnetic array 212 of the rotor 118 may be configured to fit over the stator coils 204 to interact magnetically with the stator coils 204. Other embodiments are also possible.

In some embodiments, a plurality of channels may be integrated in the stator housing to provide oil cooling of the modular stator coils 204. In an example, a seal or cover may be positioned over the plurality of coils 204 to maintain the oil around the coils 204. Further, the coil 204 may include openings or channels to allow the oil to flow between and around the wires. Additionally, the core may include slits or openings to allow for oil flow into and through the core. In some implementations, the slits or openings in the core may be curved to align to the curved magnetic field lines. Anisotropically thermally conductive materials, such as pyrolytic graphite or other materials, may be incorporated in the laminate core to further enhance cooling capacity of the slits or openings. Other implementations are also possible.

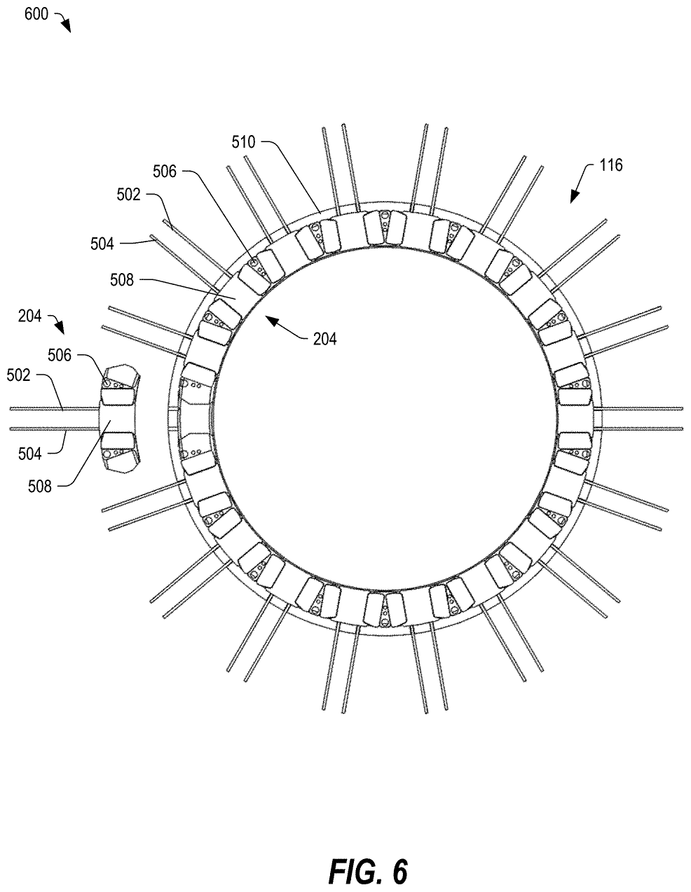

FIG. 6 depicts a top view 600 of the stator assembly 116 of FIGS. 1-5, in accordance with certain embodiments of the present disclosure. The stator assembly 116 includes a plurality of modular stator coils 204. Each stator coil 204 may include the input 502, the output 504, the coil 506, and the laminate core 508. The plurality of the stator coils 204 may be electrically and mechanically coupled to the base 510 to form the stator assembly.

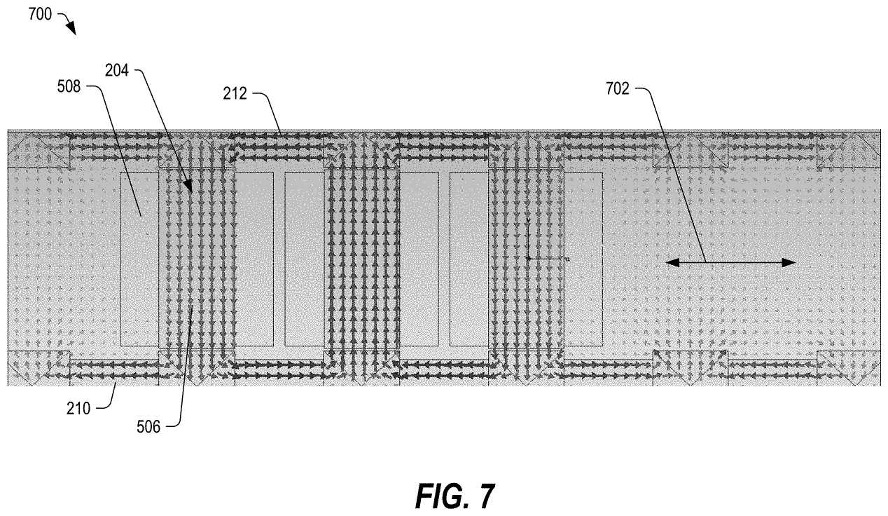

FIG. 7 depicts a top view 700 of a portion of the motor of FIGS. 1-6 depicting field lines extending between the inner magnet array 210 and the outer magnet array 212 through stator coils 204 positioned between the arrays 210 and 212, in accordance with certain embodiments of the present disclosure. The magnet arrays 210 and 212 may be formed from a plurality of small magnets coupled to one another and/or arranged to direct magnetic field lines through the coils 402 and through the arrays 210 and 212, reducing or eliminating magnetic field line leakage outside of the arrays 210 and 212, thereby enhancing overall efficiency. The current flowing in the coils 204 induces a magnetic field in the stator assembly 116, which interactions with the permanent magnets of the arrays 210 and 212 to cause the arrays 210 and 212 to move along a path indicated by arrow 702. Other embodiments are also possible.

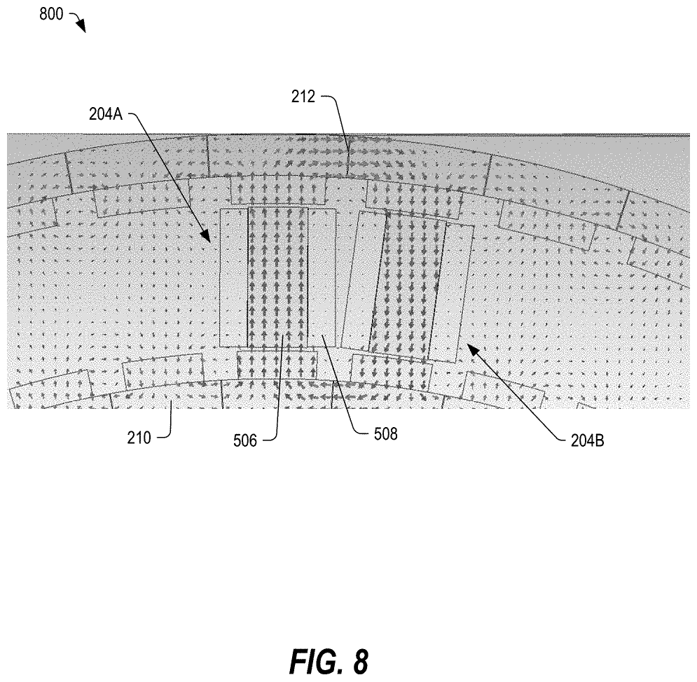

FIG. 8 depicts a top view of a portion 800 of the motor of FIGS. 1-7 depicting magnetic field lines and curvature of the arrays 210 and 212 and the stator assembly 116, in accordance with certain embodiments of the present disclosure. In the illustrated example, magnetic field lines form a closed circuit extending from the inner magnet array 210 through the coil 204A to the outer magnet array 212. The field lines flow through a portion of the outer magnet array 212 and return to the inner magnet array 210 through a second coil 204B. The magnetic field circuit applies torque to the inner magnet array 210 and the outer magnet array 212, causing the arrays 210 and 212 to turn.

It should be appreciated that the inner and outer magnet arrays 210 and 212 are formed from a plurality of magnets of approximately the same size, such as within limits of manufacturing tolerances. The magnets may be coupled and/or arranged to direct the magnetic field lines, and the sides of the magnets may be coated to further facilitate the directing of the field lines, such that the magnetic arrays 210 and 212 experience little or no magnetic field line leakage outside of the arrays 210 and 212. This makes it possible to use lighter materials to encase the arrays 210 and 212 than would be possible in conventional arrays, in part, because conventional systems use heavy metallic materials in order to contain the magnetic fields, which is not a concern with the arrays 210 and 212.

Each independent magnetic circuit module may include an inner magnetic source and an outer magnetic source spaced apart by a distance defining a channel sized to receive a central magnetic source (e.g., the magnetic coil). The inner and outer arrays 210 and 212 may be formed from permanent magnets, electromagnets, or any combination thereof. The magnetic poles of the inner magnetic source and the outer magnetic source may be offset by half of a pole pitch. The magnetic pole alignment of the central magnetic source may be parallel to a center line between the inner magnetic source and the outer magnetic source. In the circular arrangement of FIGS. 3-6, the pole alignment of the central magnetic source (e.g., the magnetic coil 204) may be parallel to a tangent line of each of the inner magnet array 210 and the outer magnet array 212 at a center point of the central magnetic source.

In some embodiments, the array of independent magnetic circuits allows for the use of non-magnetically conductive structural elements. Additionally, the independent magnetic circuit modules may reduce the need for mechanically derivative “phase windings” and can be arranged to achieve uniform circular motion about a central axis. In some embodiments, each of the magnetic coils 204 of the array of magnetic coils may be independently controlled to provide segmented, individual, independent actuation of the rotor. In the circular magnetic arrays, sets or “pole pairs” of inner and outer magnetic sources can be added to abate the magnetic alignment or magnetic “locking” of a rotating assembly.

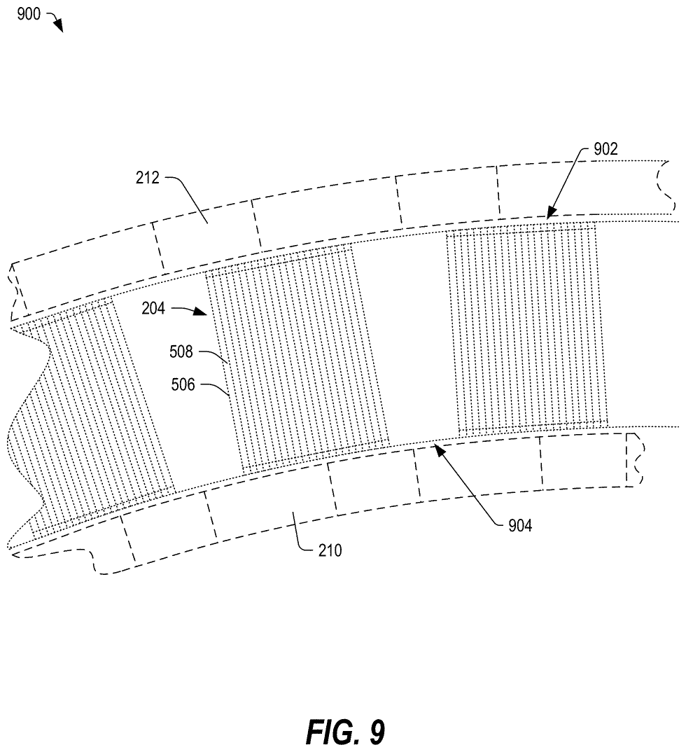

FIG. 9 depicts a portion 900 of the motor 104 of FIGS. 1-8 including portions of the inner and outer magnetic arrays 210 and 212 and the stator assembly 116, in accordance with certain embodiments of the present disclosure. The portion 900 depicts a close up view of individual magnetic circuit modules in the circular array. Each magnetic coil 204 (e.g., central magnetic source) may include a coil 506 wrapped around a laminate core 508. Each magnetic coil 204 may be individually and independently controlled to produce a desired magnetic torque, which may cause the rotor 118 to turn based on magnetic interaction between the field produced by the coil 204 and the magnetic fields produced by the inner and outer magnets 210 and 212.

The magnetic circuit modules formed by a pair of adjacent coils 204 and the magnets of the inner array 210 and the outer array 212 allow for the electromagnetic work to be done in the “gap” between the coils 204 and the arrays 210 and 212 (i.e., gaps 904 and 902).

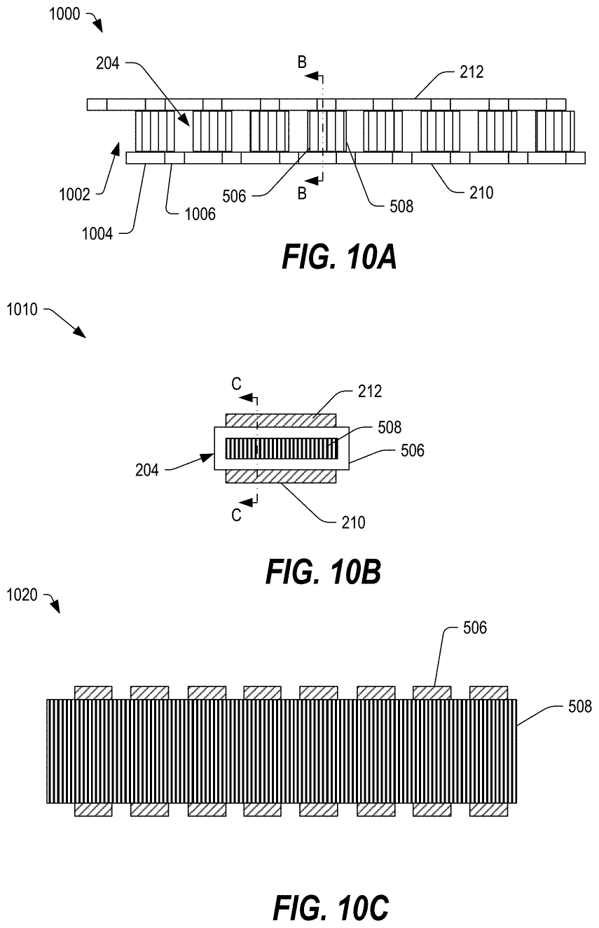

FIG. 10A depicts a portion 1000 of the motor 104 of FIGS. 1-10 rearranged as a Halbach array, in accordance with certain embodiments of the present disclosure. In this example, the inner magnetic array 210 may include a plurality of permanent magnets arranged to provide a spatially varying magnetic field. The outer magnetic array may also include a plurality of permanent magnets arranged to provide a spatially varying magnetic field. The magnetic poles of the magnets of the inner magnetic array 210 may be offset from the magnetic poles of the magnets of the outer magnetic array 212 by a selected percentage of the pole pitch. In a particular embodiment, the offset may be approximately half of the pole pitch.

The central magnet source may fit within the channel 1002 between the inner magnetic array 210 and the outer magnetic array 212. The central magnet source may be formed by a plurality of electromagnetic coils 204. Each electromagnetic coil 204 may include a plurality of coils of a conductive wire 506 wrapped around a laminate core 508.

In the illustrated example of FIG. 10A, the magnets of the inner array 210 and the magnets of the outer array 212 are depicted as being formed from different sized magnets, such as a magnet 1004 that is depicted as being larger than the adjacent magnet 1006. It should be understood that the relative sizes of the magnets are provided for illustrative purposes only. In implementation, the sizes may vary. In a particular embodiment, the arrays 210 and 212 may be formed from a plurality of magnets that are all the same size and that have the same magnetic properties. The magnets may be arranged in series and in particular orientations to direct and contain the magnetic fields. By utilizing this configuration, the magnetic fields can be easily contained by the magnetic arrays 210 and 212 with little or no magnetic field leakage outside of the periphery of the magnetic arrays 210 and 212. Thus, the configuration of magnets of the arrays 210 and 212 may provide improved efficiency relative to an array with variable size and/or larger magnets. In an embodiment, the larger magnets may be formed by a plurality of small magnets coupled in series.

FIG. 10B depicts a cross-sectional view 1010 of the Halbach array taken along line B-B in FIG. 10A. In the view 1010, a magnetic module is shown that includes the magnetic coil 204 including the coil 506 and the laminate core 508 and including inner magnets and outer magnets of the inner array 210 and the outer array 212, respectively.

FIG. 10C depicts a cross-sectional view 1020 of a magnetic coil assembly taken along line C-C in FIG. 10B. The view 1020 includes the laminate core 508 and wires of the coil 506.

In some embodiments, current flowing through the wire of the coils induces a magnetic field having poles that extend out of ends of the laminate core 508. The ends are the sides of the laminate core 508 in FIG. 10C that are not contacted by the coil 506.

In operation, the magnetic field of the magnetic coil 204 extends out of the ends of the magnetic coil 204 and couple to the magnets of the inner magnetic array 210 and the outer magnetic array 212, applying a magnetic force to the magnets of the arrays 210 and 212 to move the rotor 118.

In some embodiments, by driving current into the magnetic coils 204, the laminate core may be driven into partial saturation. The magnetic coils 204 assist in closing a magnetic circuit between the inner and outer magnet arrays 210 and 212. By controlling current flow through the magnetic coils 204, the magnetic coils 204 may cooperate to apply torque to the inner and outer magnet arrays 210 and 212 to move the rotor 118 relative to the stator assembly 116. Other embodiments are also possible.

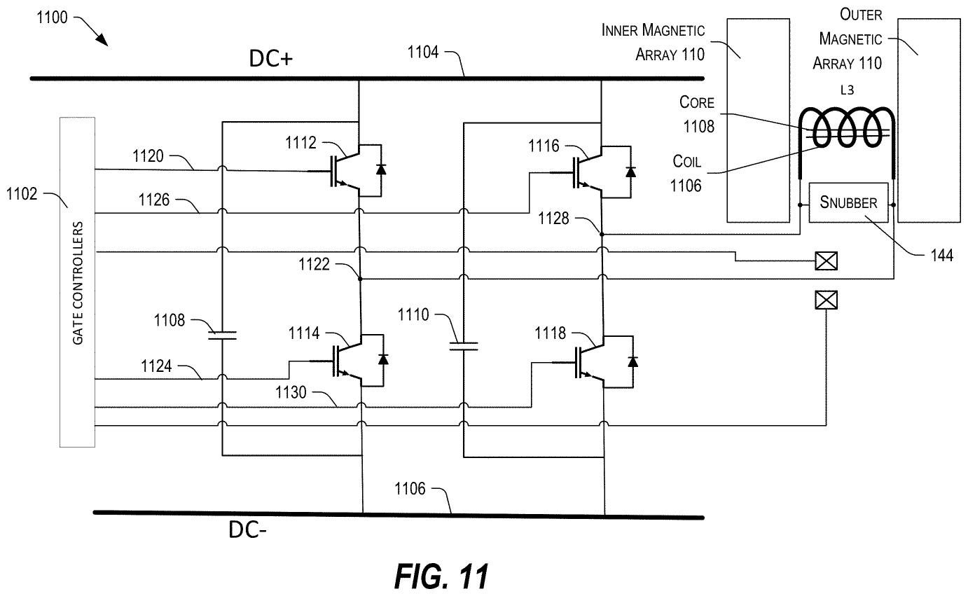

FIG. 11 depicts a system including a circuit 1100 configured to drive a magnetic coil assembly, in accordance with certain embodiments of the present disclosure. The circuit 1100 may be an embodiment of at least a portion of the circuit 112 in FIG. 1. The circuit 1100 may include a gate driver circuit 1102, which may be part of the circuitry 112 described with respect to FIG. 1. The circuit 1100 may further include a first power bus 1104 and a second power bus 1106. The circuit 1100 may further include a capacitor 1108 and a capacitor 1110, each of which may be coupled between the first power bus 1104 and the second power bus 1106. The circuit 1100 may also include an H-Bridge configuration including transistors 1112, 1114, 1116, and 1118. The transistor 1112 may include a drain coupled to the first power bus 1102, a gate coupled to the gate driver circuit 1102 by a node 1120, and a source coupled to a node 1122. The node 1122 may be coupled to a first end of a winding 1106 around a core 1108 of the plurality of electromagnetic coil assemblies 204. The transistor 1114 may include a drain coupled to the node 1122, a gate coupled to the gate driver circuit 1102 by a node 1124, and a source coupled to the second power bus 1106. The transistor 11116 may include a drain coupled to the first power bus 1104, a gate coupled to the gate driver circuit 1102 by a node 1126, and a drain coupled to a node 1128. The transistor 1118 may include a source coupled to the node 1128, a gate coupled to the gate driver circuit 1102 by a node 1130, and a source coupled to the second power bus 1106.

In the circuit 1100, the transistors 1112, 1114, 1116, and 1118 may include insulated gate bipolar transistors, insulated gate field effect transistors, or other insulated switches capable of switching high current, high voltage, or both. The transistor 1112 may include a first input coupled to a second end of the coil 1106 of the electromagnetic coil 204.

It should be appreciated that configuration of the transistors 1112, 1114, 1116, and 1118, and the capacitors 1108 and 1110 may be replicated for each electromagnetic coil assembly 204 so that the power switching may be controlled by the gate driver circuit 1102 to independently control the electromagnetic portion of each of the magnetic modules. Each electromagnetic coil 204 may have an associated circuit.

In the illustrated example, the gate driver circuit 1102 may selectively bias the transistors 1112, 1114, 1116, and 1118 to turn on and off to drive current through the coil 1106. The gate driver circuit 1102 may selectively activate the transistors 1112, 1114, 1116, and 1118 for each coil 1106 of an array of electromagnetic coils 204 to provide independently controllable magnetic sources.

In some embodiments, the circuit 1100 may include a snubber circuit 144 coupled to the coil 1106. The snubber circuit 144 may provide energy-absorbing functionality to suppress voltage spikes caused by inductance of the coil 1106 when the transistors 1112, 1114, 1116, and 1118 transition. The snubber circuit 144 may include a capacitor for energy storage. In some embodiments, one or more additional capacitors 1110 (which may or may not be part of the snubber circuit 144) may be included to store energy from the coil 1106 during transitions, allowing for energy capture and reuse with reduced loss, as compared to a system that would transfer the coil's energy back to a power source. It should be appreciated that the snubber circuit 144 may be an embodiment of the snubber circuits 144 of the circuitry 112 in FIG. 1. Further, the capacitors 1108 and the capacitor 1110 may be embodiments of the capacitors 146 of the circuitry 112 in FIG. 1. Other embodiments are also possible.

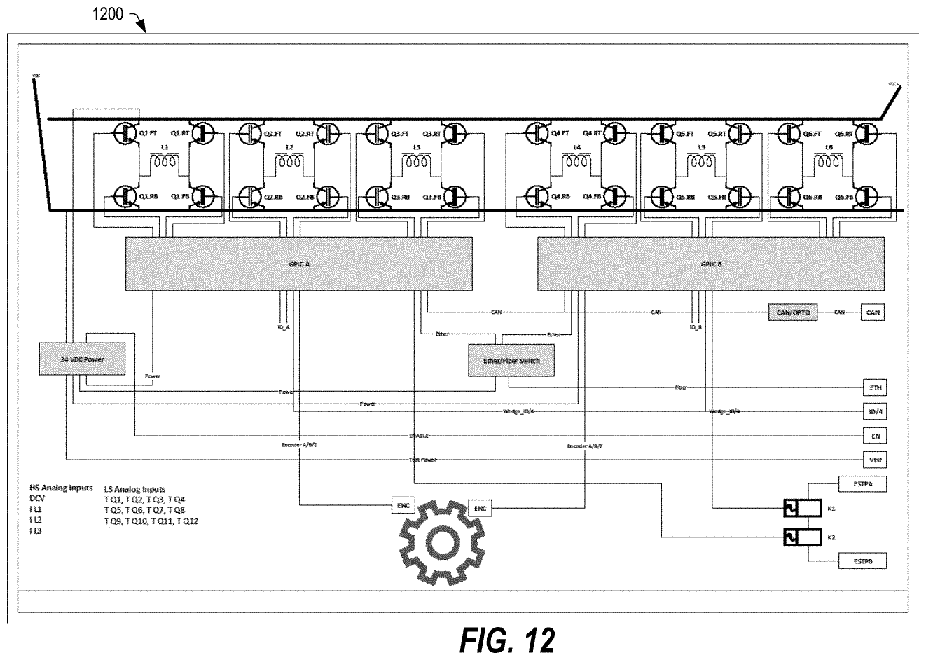

FIG. 12 depicts a simplified independent winding motor control block diagram 1200, according to a certain embodiment of the present disclosure. The circuitry 112 may use multiple position sensors and multiple current sensors (not shown) to determine position and current flow. In response to the sensor signals, a microcontroller of the circuitry 112, such as driver circuitry 1102 in FIG. 11, may be configured to control the current driven into each of the modular coils 204, and thus motor torque according to prescribed demand from the remote control system asking for a given torque and revolutions per minute (RPM).

It should be understood that the gate driver circuitry may be configured to deliver a selected waveform at a selected frequency and amplitude to each modular coil 204 independently of other modular coils 204 of the stator 116 to drive the rotor 118.

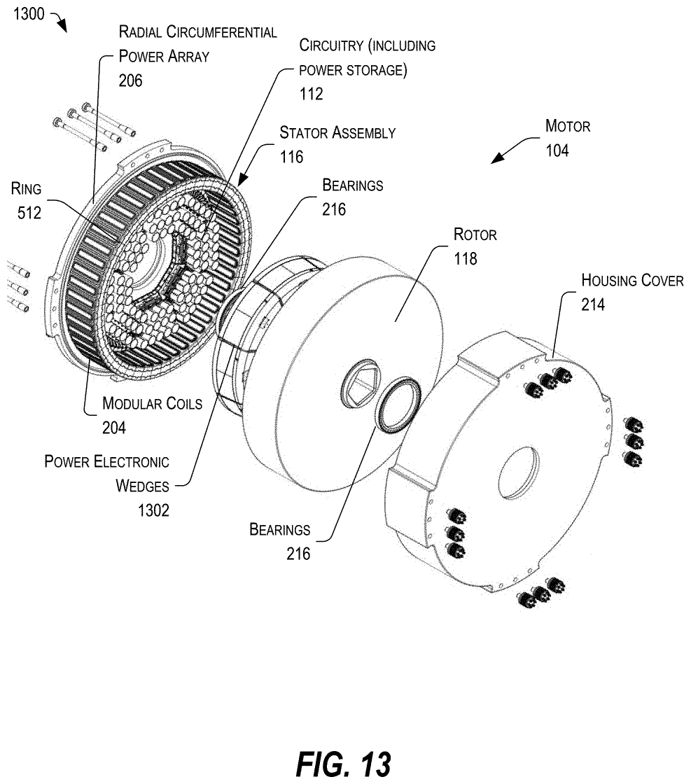

FIG. 13 depicts an exploded sectional view 1300 of motor assembly. The stator coils 204 and power electronics wedge assemblies are shown on the left. The stator magnetic field extends in the radial direction. There are two air gaps between dual magnetic arrays 210 and 212 of the rotor 118 and each coil 204 the stator 116. In some implementations, there would be an outer Halbach cylinder on the outside diameter and an inner Halbach cylinder on the inside diameter. There may be or not a return iron on the back side of the permanent magnet Halbach array. The large central shaft may be five or more sided, and may be made of high modulus composite material.

In the illustrated example, power electronic wedges 1302 are shown, which may fit within the circumferential profiles of the plurality of coils 204. Each of the power electronic wedges 1302 may independently control one or more coils 204. The power electronic wedges 1302 may be part of or may be coupled to the circuitry 112. Other implementations are also possible.

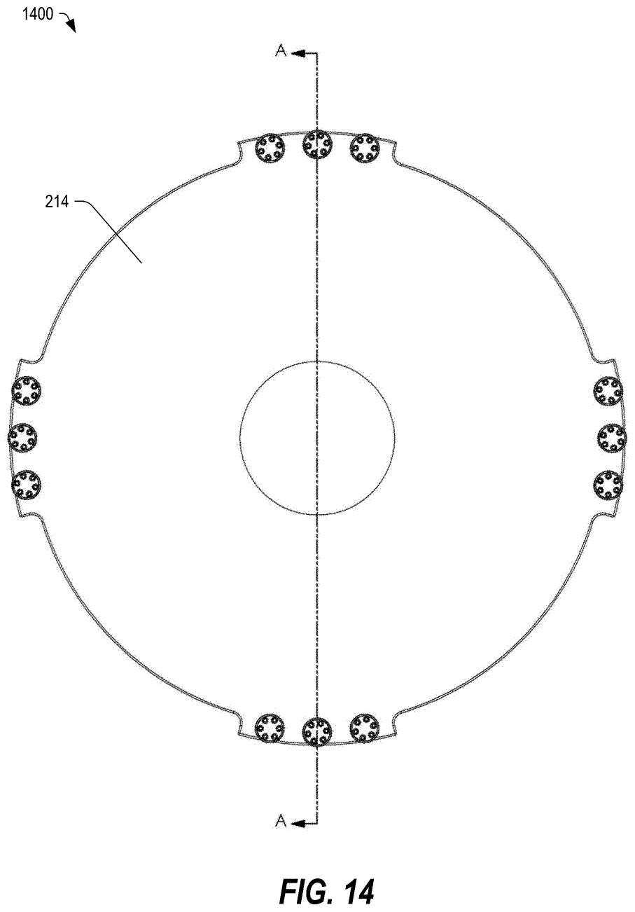

FIG. 14 depicts a front view 1400 of the housing cover 114. The cover 114 may enclose the stator 116 and the rotor 118. The circumferential radial power array 206 may be coupled to the stator 116 and bolted to the housing cover 114 to enclose the motor. In some implementations, the cover 114 may be formed from composite materials.

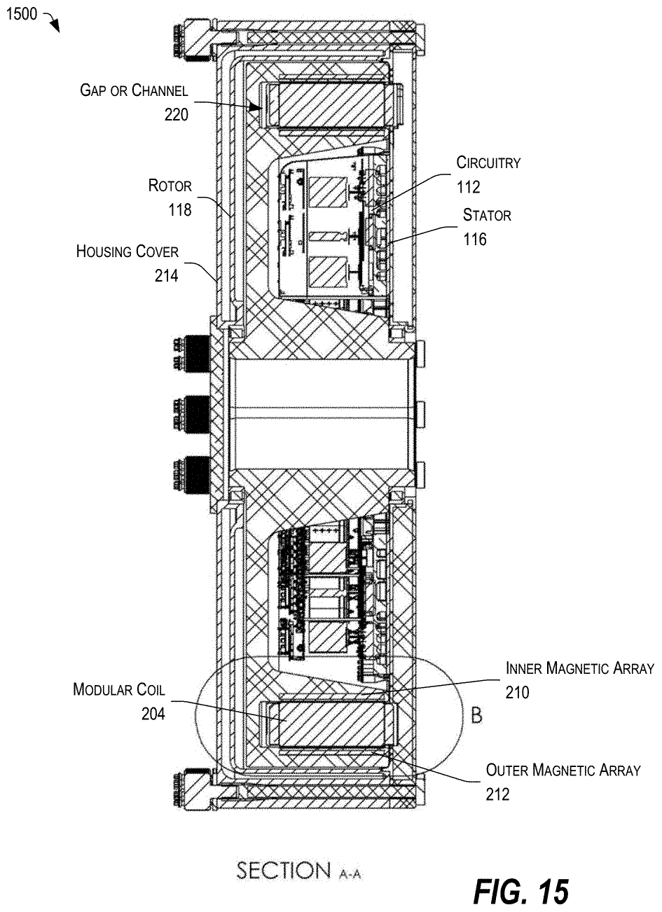

FIG. 15 depicts a motor section view (axially cut) 1500. The motor may include a cover 114 fitted over a rotor 118, which in turn includes a gap 220 or channel sized to fit over the stator coil 204. The rotor may include an inner magnetic (Halbach) array 210 of permanent magnets with their magnetic fields protruding radially outwards toward the stator wound poles. The rotor 118 also has an outer magnetic (Halbach) array 212 of permanent magnets with their magnetic fields protruding radially inwards and towards the stator wound poles.

The rotor 118 can be firmly attached to a large concentric rotating shaft that may be formed from composite material. Additionally, the shaft may be hollow and five sided. The wound stator coils 204 can have their magnetic axis directed radially. In one possible embodiment, the stator 116 may have a first number of poles, and the rotor 118 may have a second number of poles, which may be greater than the first number of poles. In one possible implementation, the stator 116 may have about forty-eight poles, and the rotor 118 may include approximately fifty-six poles. In another possible implementation, the stator 116 may have 72 stator coils 204 and the rotor may have 96 rotor poles. The motor, in such an implementation may be divided into 12 wedges, where each wedge controls one or more coils 204. The circuitry 112, including power electronics, may be located in a shielded enclosure wedge as part of the stator 116 and at a radius between the central shaft and the inner magnetic (Halbach) array 210.

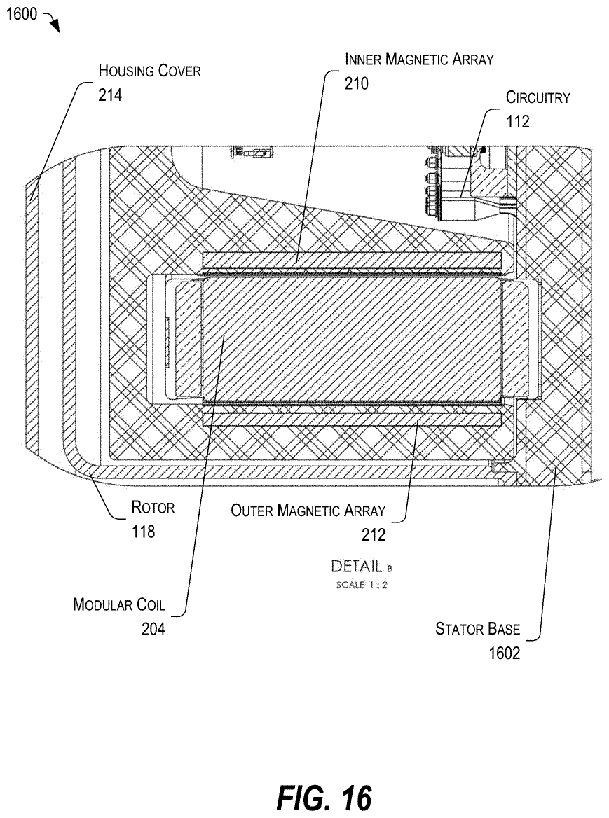

FIG. 16 depicts a rotor magnetic circuit cross-sectional view 1600, in accordance with certain embodiments of the present disclosure. The view 1600 is taken along the cut-out in FIG. 15. The view includes the housing cover 214, the rotor 118, a stator 116, and a stator base 1302. The view 1600 includes the inner magnetic (Halbach) array 210 of permanent magnets with their magnetic fields protruding radially outwards (down in this view) toward the stator wound poles. The view also includes the outer magnetic (Halbach) array 212 of permanent magnets with their magnetic fields protruding radially inwards (up in this view) and towards the wound poles of the stator 116. The modular stator coils 204 have their magnetic axis directed radially (up and down in this view). In some embodiments, the stator 116 may have about forty-eight poles, and the rotor 118 may have approximately fifty-six poles. The winding leads connecting to the power electronics are shown in the upper right corner. The magnetic gap 220 between magnetic arrays 210 and 212 of the rotor 118 and the modular coils 204 of the stator 116 may be of the order of one centimeter or less.

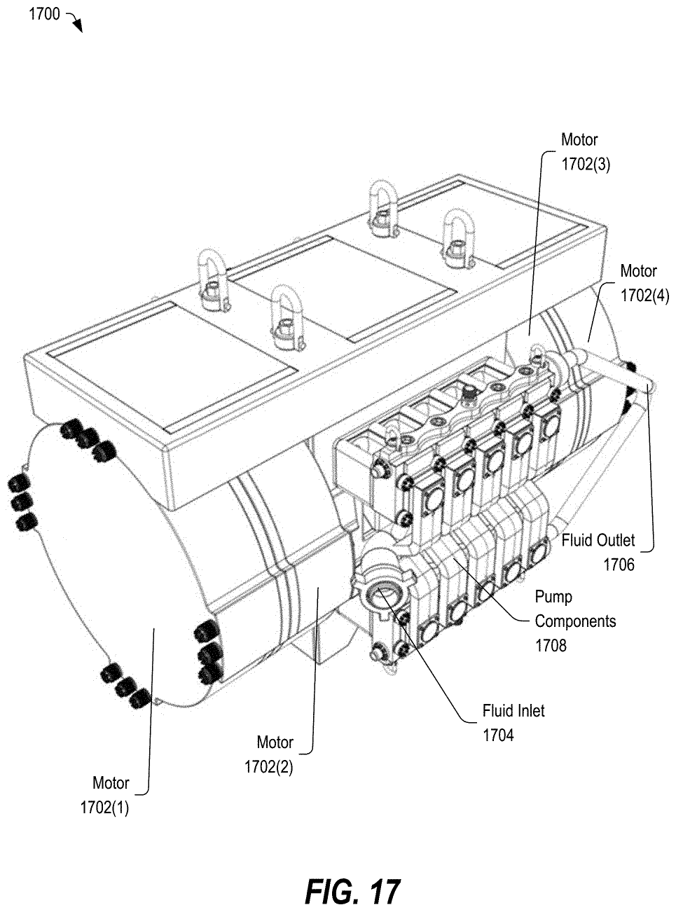

FIG. 17 depicts a device 1700 including four motors 1702 configured to drive pump components 1708 on a common shaft, in accordance with certain embodiments of the present disclosure. There are two motors 1702(1) and 1702(2) facing each other on the left and two motors 1702(3) and 1702(4) on the right. The motors 1702 are all mounted on a common high strength shaft going through cylinder central axis and through the pump components 1708, which form a high pressure pump. The details of this high pressure pump are further detailed in another non-provisional patent application Ser. No. 16/373,583 filed on Apr. 4, 2019 and entitled “Pump Apparatus with Reduced Vibration and Distributed Loading”, which is incorporated herein by reference in its entirety.

In the illustrated example, the device 1700 may include a fluid inlet 1704, a fluid outlet 1706, and a plurality of pump components 1708 configured to receive fluid from the fluid inlet 1704 and to drive the fluid through the fluid outlet 1706 at high pressure. The motors 1702 may cooperate to turn a shaft that drives the pumping elements. Other implementations are also possible.

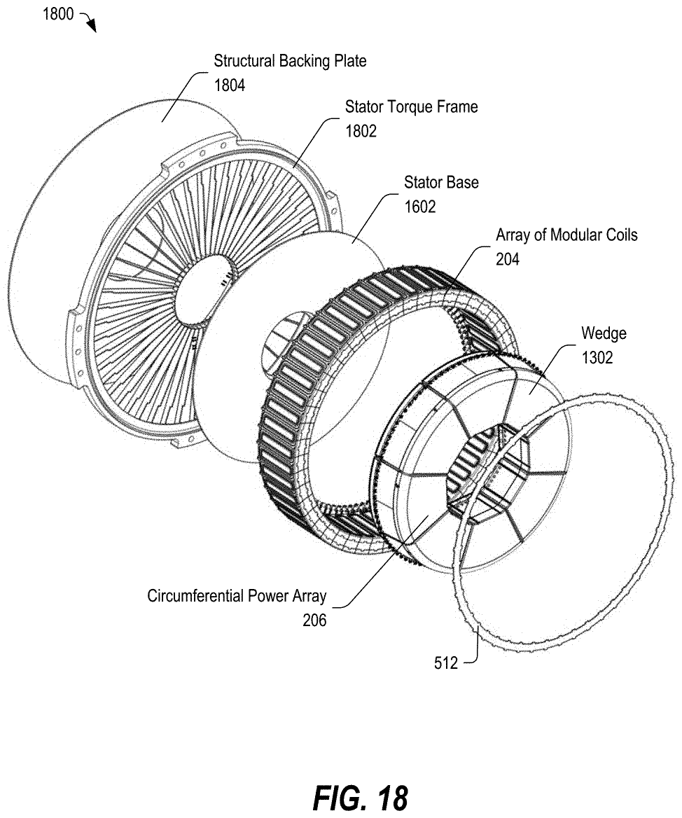

FIG. 18 depicts an exploded view 1800 of stator assembly 116, in accordance with certain embodiments of the present disclosure. The view 1800 shows a stator torque frame 1802, a structural backing plate 1804, and a stator base 1602. The circumferential array of coils 204 is shown in the center and the integrated circumferential power array 206 is on the right. Each of the eight wedges 1302 may operate at progressing higher voltages of about 1 kV. Further, the view 1800 shows a ring 512 to fit over the distal ends of the coils 204.

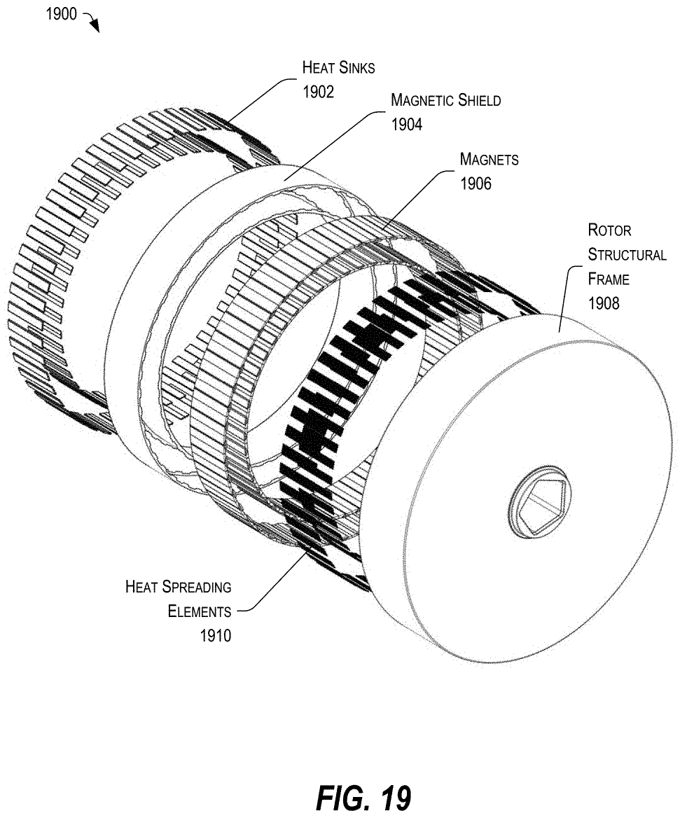

FIG. 19 depicts an exploded view 1900 of the rotor 118, in accordance with certain embodiments of the present disclosure. The inner magnetic (Halbach) array 210 and the outer magnetic (Halbach) array 212 may be formed from magnets 1902 and 1904 respectively, which are shown on the far left. The view 1902 may further include an array housing 1906 to secure the outer magnets 1902 and the inner magnets 1904. The view 1902 may further include a rotor structural frame 1908, array shielding 1910, and back iron 1912, which cooperate to form the rotor 118. The rotor structural frame 1908 is shown on the right and may be of metal or of composite material. The rotor 118 may be coupled to a large central shaft that may be hollow, and formed of composite material.

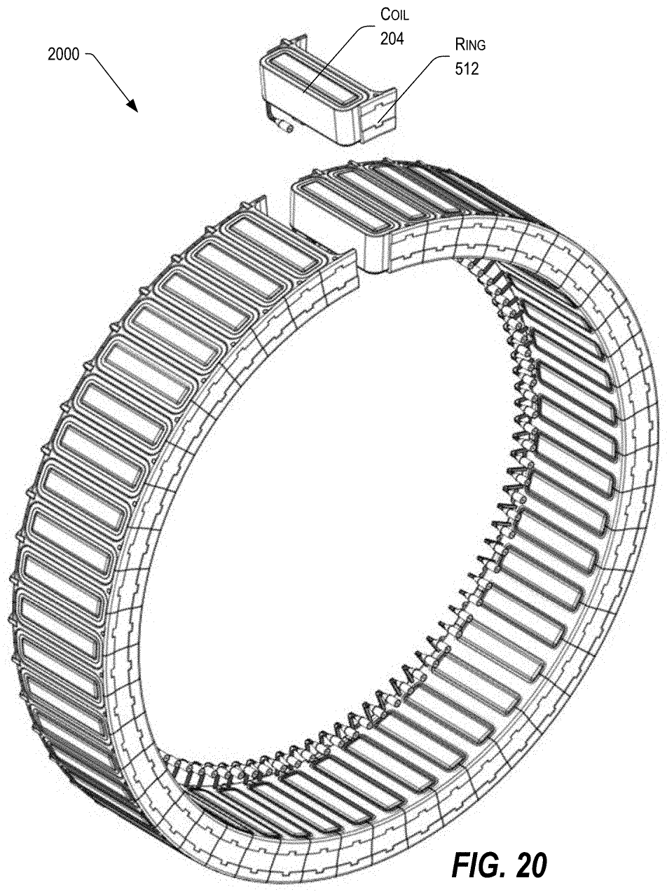

FIG. 20 depicts a stator electromagnetic array 2000 with one modular coil 204 separated for clarity, in accordance with certain embodiments of the present disclosure. There may be approximately forty-eight wound modular coils 204 or poles with a radial magnetic field. Each coil 204 consists of a stack of steel lamination of the order of 12×12×4 inches. The lamination can be mounted so the motor axis of rotation is normal to the individual laminations surface. Alternatively, the coil 204 may comprise a composite core with windings wrapped about the core. The windings around the laminations may have a build of the order of one inch. The windings may be wire or sheet wound. The stator 116, rotor 118, and power electronics 1302 may all be immersed in transformer oil for electrical insulation and cooling. The oil can also serve as lubrication for the central bearing lubrication. In certain embodiments the dielectric cooling oil is the same as the bearing lubrication oil but may be kept separate to prevent any potential contamination and degradation of the dielectric cooling oil. Spray cooling of the rotor may be incorporated in the bearing lubrication circuit in other embodiments.

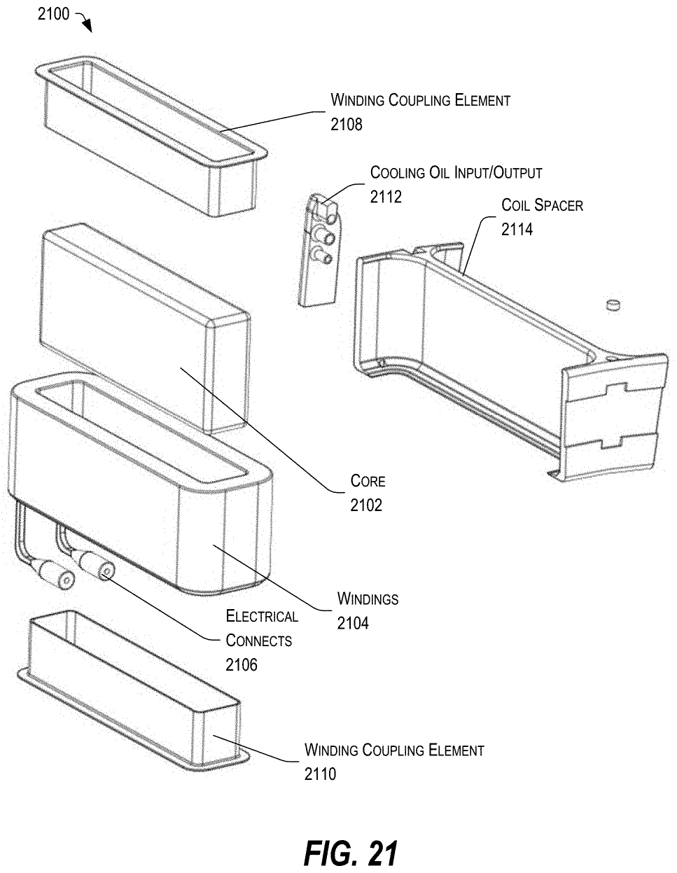

FIG. 21 depicts an exploded view of electromagnet array element or coil 204, in accordance with certain embodiments of the present disclosure. There may be approximately forty-eight wound rotor poles or coils 204 with a radial magnetic field. Each coil 204 may consist of a stack of steel lamination or composite lamination 2102 of the order of 12×12×4 inches. The lamination 2102 can be mounted so the motor axis of rotation is normal to the individual laminations surface. The windings 2104 around the laminations 2102 may have a build of the order of one inch and may include electrical connections 2106. The windings 2104 may be wire or sheet wound. The coil 204 may further include winding coupling elements 2108 and 2110 to couple to the core 2102 and to secure the winding 2104 to the core 2102. The coil 204 may further include a cooling oil input/output element 2112. Further, the coil 204 may include a coil spacer to secure and separate adjacent coils 204. Other implementations are also possible.

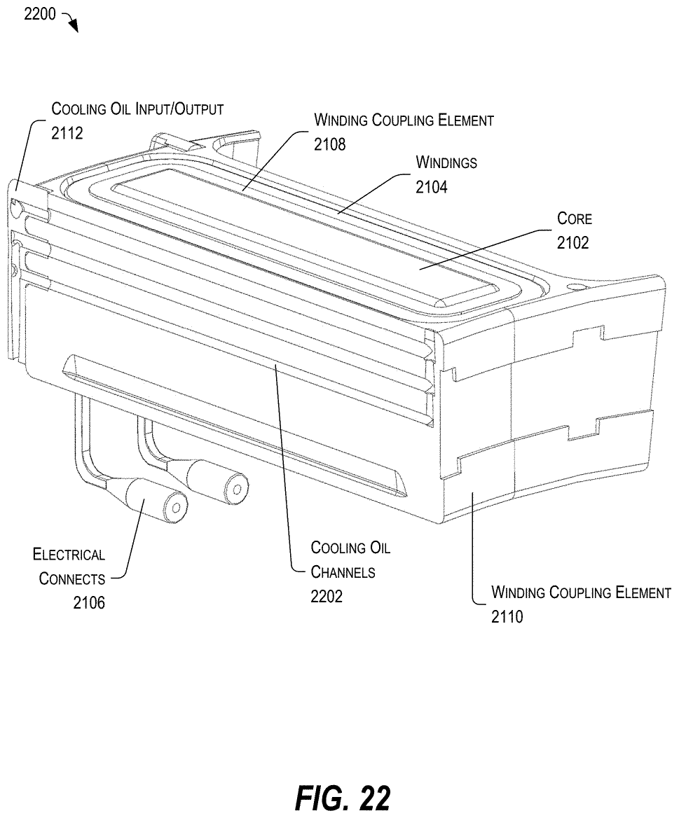

FIG. 22 depicts a view 2200 an electromagnet array element or coil 204 detail view, in accordance with certain embodiments of the present disclosure. This figure depicts the central lamination core 2102 and surrounding windings 2104 and electrical connects (or leads) 2106. A high strength non-conductive structural arch wedge (or winding coupling element 2110) is also shown.

Winding coupling element 2108 is shown, which couples to the core 2102 to secure the windings 2104 to the core 2102. The modular coil 204 further includes a cooling oil input/output 2112, which is coupled to cooling oil channels 2202, which surround the windings 2104 and the core 2102.

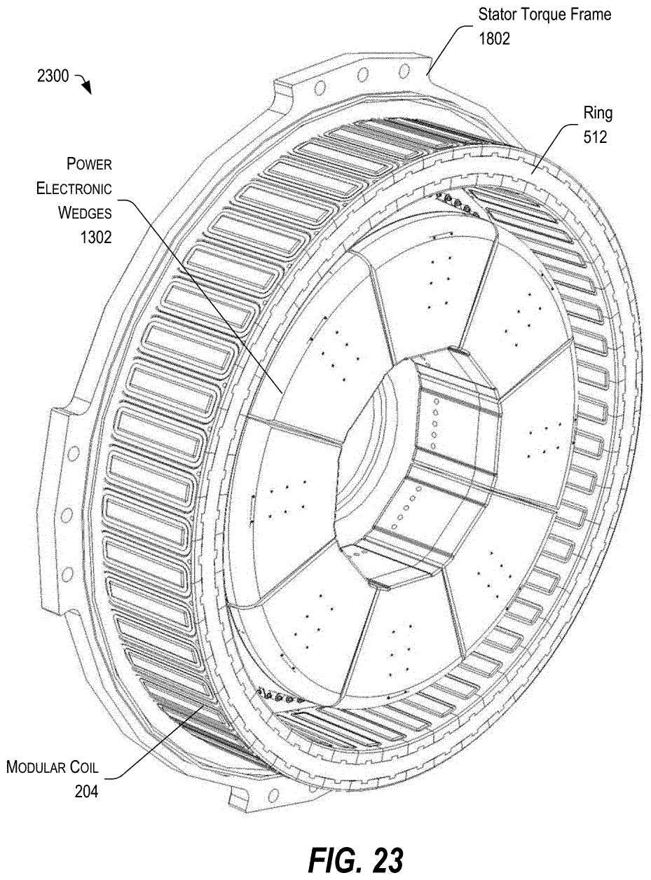

FIG. 23 depicts a stator array 2300 with associated power electronics wedge assemblies 1302, in accordance with certain embodiments of the present disclosure. The stator 116, as shown in the array 2300, may have about forty-eight radial magnetic field poles mounted on a rear stiff round plate and a stator torque frame 1802. The stator 116 may have eight separate electrically isolated full bridge hot deck wedges 1302, each of which may control each of six modular coils 204 independently of one another and independently of modular coils 204 of others of the wedges 1302. The ring 512 may secure the distal end of each of the coils 204. In some embodiments, microcontrollers of each wedge may share certain redundant information such as the precise rotational angle of the motor in order to ensure high reliability and long life.

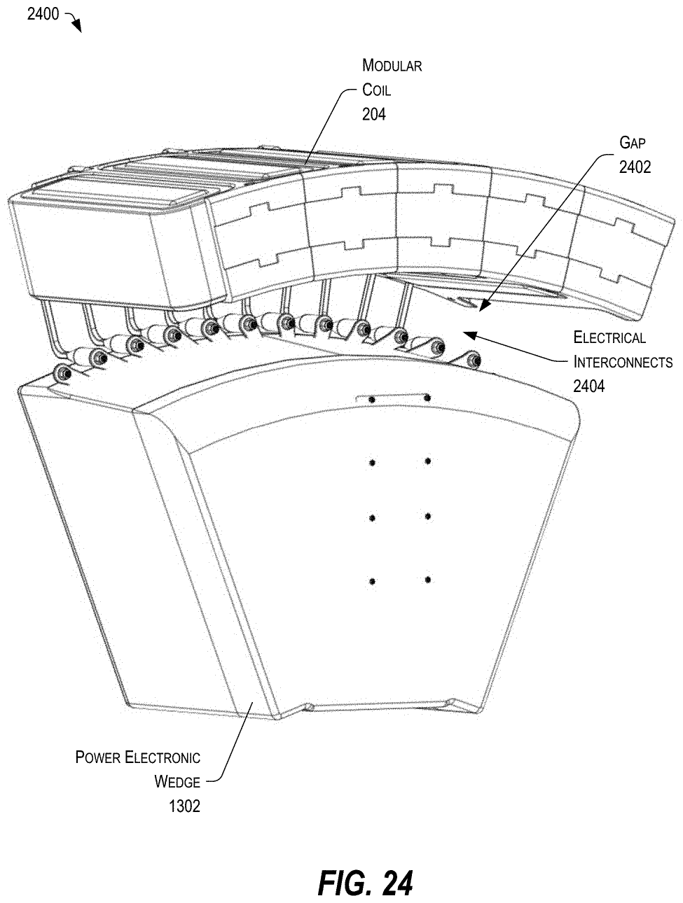

FIG. 24 depicts a perspective view 2400 of a stator power electronics wedge 1302 connected to coils 204 and electromagnetic element assembly, in accordance with certain embodiments of the present disclosure. In this embodiment, the stator coils 204 can be mounted into a stiff tangential arc.

The modular coil 204 may be separated from a power electronic wedge 1302 by a gap 2402, which provides space for the inner magnetic (Halbach) array 210 of the rotor 212. Further, electrical interconnects 2404 may couple the power electronics of the wedge 1302 to the modular coils 204.

In this example, the view 2400 shows six coils 204 coupled to the power electronic wedge 1302. The power electronic wedge 1302 may include control circuitry and driver circuitry, as shown with respect to circuitry 112 in FIG. 1, which may independently control each of the six coils 204 relative to one another. Further, the power electronic wedge 1302 may communicate with other power electronic wedges 1302 to coordinate operation within the motor and without requiring communication with an external control system. In some implementations, the power electronic wedges 1302 may be self-contained and may be configured to cooperate with one another to provide fail-over support, load-balancing, and other functions based on inter-wedge communications.

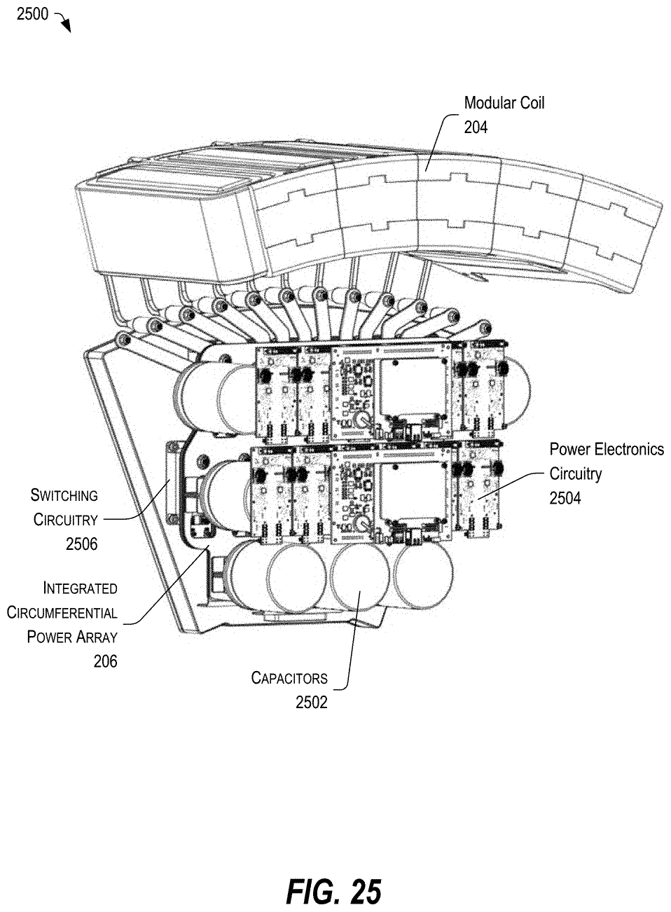

FIG. 25 depicts the power electronics wedge assembly 2500 with protective cover removed for clarity, in accordance with certain embodiments of the present disclosure. The assembly 2500 may include modular coils 204, coupled to circuitry 112, which may include or be coupled to capacitors (or other power storage elements) 2502 and which may include or be coupled to power electronics circuitry 2504. The assembly 2500 may further include switching circuitry 2506, such as insulated-gate bipolar transistors (IGBTs), which can be mounted on a rear forced oil cooled heat sink. In other implementations, other power electronic modules of Silicon carbide (SiC) or other materials may be substituted for IGBTs to provide similar functionality. The heat sink may have multiple oil cooling channels in the rear. The next major layer may be formed by a parallel array of DC link or bus storage capacitors 2502. The top component layer can include the power electronics control circuitry 2504 for the whole wedge. The capacitors 2502, the control circuitry 2504, and the switching circuitry 2506 may be coupled to the integrated circumferential power array 206. Certain embodiments may include devices to pre-charge or remove energy from the DC link capacitor banks, for service and in the event of emergency shut-down.

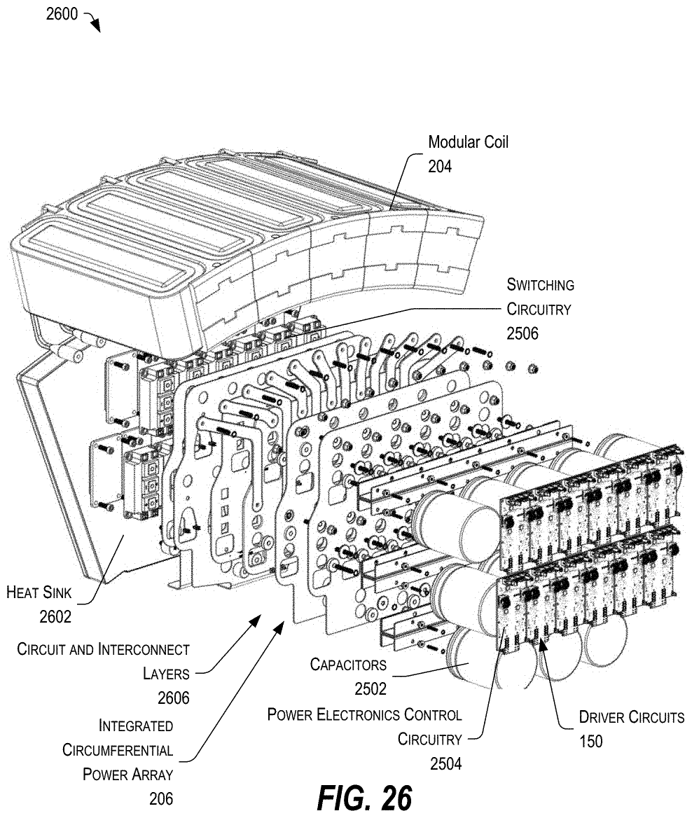

FIG. 26 depicts a further exploded view of power electronic wedge assembly 2600 with the protective cover removed, in accordance with certain embodiments of the present disclosure. From the far left to the far right, there is the forced oil cooled heat sink 2602, switching circuitry 2506, and multiple circuit and interconnect layers 2606 (circuit 112), including the integrated circumferential power array 206, which may be formed of copper and G-10 insulated bus materials. The view 2600 further includes capacitors 2502 and power electronics control circuitry 2504, including gate driver circuits 150.

In a particular embodiment, the motor may include a stator assembly and a rotor assembly. The rotor assembly may include a first magnetic array and a second magnetic array that are separated by a channel having a depth that extends in a direction that is substantially parallel to an axis of rotation of the rotor assembly. The stator assembly may include a plurality of electromagnets configured to fit within the channel and adapted to generate a time-varying magnetic field to apply a motive force to the rotor assembly. In some embodiments, a control circuit may selectively apply current to the electromagnets independently and at selected phases. In a particular example, the control circuit may drive the electromagnets with any number of different phases.

The motor and its components, described above with respect to FIGS. 1-36, may be configured to enhance performance (torque at desired rpm) within limits of machine health management on a continuous or burst mode basis, within each coil and power electronics unit. Normally efficiency can be maximized to minimize losses and heat generated at the desired power level, which can be achieved through switch-on/off and pulse-width-modulation (PWM) optimization, incorporating feedback from machine health management sensors and computations. In some embodiments, the circuitry 112 may be configured to provide graceful/soft failure mitigation, such as by controlling individual control electronics for each coil, reducing stress on coil insulation or power electronics prior to coil short or other failure. Electromagnetic fields (EMF) following in each coil and power electronics unit may reduce any contribution to torque ripple, acoustic noise or negative impact on torque at any rpm.

In some embodiments, the motor control may be implemented to operate in a dual-quadrant or four-quadrant configuration, but the magnetic circuits may be segmented into any number of sectors, depending on the power electronics grouping/implementation. The modularity and versatility allows for a wide range of DC link voltages while ensuring that each quadrant uses similar power, which may also extend machine life and provide significant flexibility and redundancy for fault tolerance.

In some embodiments, the radial circumferential power array and the associated power electronics design can utilize series/parallel power switching architectures incorporating gate drives with sensing, gradual switching, staged switching, and other measures to identify and manage fault conditions. Networked deterministic microcontrollers may be included to perform real-time transforms as gate control signals optimize switching to manage electromagnetic cycle energy. Rapid graduated shutdown features may be implemented to minimize fault currents in less than 1 microsecond.

In some embodiments, controller and communication functions may allow multiple feedback loops and DC link supply control management. These functions can allow for power electronics communication and coordination prior to increasing demand in electrical machine, maximizing system response and power distribution system stability.

Embodiments of the motors and components and systems described above with respect to FIGS. 1-26 may provide significant advantages in performance, efficiency, weight, and design scalability over conventional motors. The advantages can be realized for different sizes and torque motors and generators, from approximately 100 kilowatts to motors/generators in the 5 to over 10 megawatt range. Further, the motor may be scaled to operate with 1800 to 3600 RPM generators that operate in the 8-12 megawatt range. All of these implementations can have a high power and very high power density operation, which can work well with the DC power distribution and nearby power electronics disclosed herein.

In some embodiments, the embodiments described above with respect to FIGS. 1-26 may include high power, multichannel IGBT gate drives. Each of the 48 coils can include four IGBT isolated gate drives, power supplies, and signal isolators. These gate drives can be extremely compact, high power, physically rugged, oil cooled, and oil compatible. Further, the embodiments may include series/parallel combinations of IGBTs to facilitate operation, controls, self-protection, and personnel safety. Other embodiments are also possible.

In some embodiments, the power supply to the motor or the power electronics within the motor may include a microsecond speed fast solid state circuit breaker. The solid-state circuit breaker may utilize multiple IGBTs to hold off the 8 kVDC plus voltage transients. In other embodiments, the solid-state circuit breaker may be used to hold off 12 kVDC plus voltage transients. High speed may be used to quickly interrupt fault currents before large currents are produced. Low fault currents produce much less damage and can arc flash, making the low fault currents much safer for operator personnel nearby.

In some embodiments, the high power multiphase motor can include both sensor-based and sensor-less control. These may be implemented as modes of operation or may depend on the particular control being exercised. As discussed above, the motor may include a 48-pole dual Halbach radial field rotor configured to rotate about an axis, which motor is described above. Further, the motor may utilize a series H-bridge for switching control and operation. In an example, the 48 coils and the fully independent H bridges may be connected as six bridges with their DC input buses in series in a wedge enclosure and with 8 such wedges connected in series. Ancillary voltage sensors and control electronics can be used to ensure that the 8 kV DC is always divided evenly between the 8 wedges. Other power division and control embodiments are possible.

In some embodiments, each of the wedges, the entire system, the control electronics, or any combination thereof may utilize compact high current, low inductance IGBT buses. The above discussion includes a description of the IGBT cooling plate, low inductance laminated bus work sheets, isolated gate drives, and control electronics stacked inside the 8 wedges.

In some embodiments, each of the 48 coils may include a compact high current and high speed current sensor. The custom and rugged Hall Effect sensor does not include ferrous materials, is may be highly insensitive to the intense electromagnetic noise inside the motor. Additionally, the sensor(s) may be is oil compatible, facilitating cooling and electrical isolation.

Further, the motor may include integrated high power EMI shielding. All of the electronics inside the wedges are protected by an aluminum shield enclosure, which may be hardened to the 1 kV level seen inside the wedge. The wedge may provide an insulated hot deck so the internal electronics do not see the 8 kV fields.

Additionally, the device may include integrated thermal management of power electronics. The IGBTs and associated circuitry can be mounted on a forced oil cooled cold plate. The drive electronics can be immersed in mineral or silicon oil for electrical insulation and cooling. Oil cooling permits much higher power density of every single component and completely seals the unit against the harsh environment of the frack field. The IGBTs will be completely submerged in oil, and IGBT oil compatibility issues have been mastered by utilizing oil-compatible electronics and multimode fiber optics. Additionally, the circuitry can make use of high current oil-cooled capacitors. Further, the motor may utilize two or more high-current and high-voltage bus bars within the oil enclosure.

With respect to the magnetic motor, the high power multi-phase permanent magnet motor analytical calculations have been completed, and have demonstrated significant advantages. The calculations include permanent magnet operating points control of large, low-speed multi-phase permanent motor. Further, the motor includes a laminated low-lost rotor configuration. The rotor magnets may be made of many smaller magnet stacks to minimize eddy current losses. The size and proper orientation of the magnets, so as to not intersect varying fields has been determined and is also claimed. In some embodiments, the rotor may include a slot-held permanent magnet rotor configuration, such that the permanent magnets are held in place by slots in the carbon fiber rotor. Alternatively, the permanent magnets may be embedded as part of the fiber assembly process.

In some embodiments, the stator overhang configuration including the mounting of the coils is described in the above discussion. An alternate mounting scheme may utilize a separate mounting ring on the face of the stator as well as the previously described large circular back plate.

In some embodiments, the motor may also include oil-cooled coil insulation. All motor components including rotor, stator and drive electronics can be immersed in oil for cooling and high voltage insulation and for viscosity drag mitigation. Oil drag can be mitigated by low viscosity oil at operating temperature, large and smooth gap, and low rpm.

In some embodiments, a single-shaft motor-to-motor high circulating power test configuration is possible. Two or more motors on a single shaft can be tested as a motor and generator where the two DC buses are connected in parallel. In this scenario, the motor and generator can be functioning at full power (5 MW or so each) and the required utility power is only the losses of a few hundred kW each, which may be a great simplification in terms of required prime power and load cooling. The same scheme can be used with a single 8 wedge motor, for example, by using the 4 even numbered wedges as a motor and the four odd wedges as a generator. In a particular embodiment, the wedges could be set up as 4 kV DC systems or as a bank of 8 parallel 1 kV wedges. Multiple variations are possible, depending on the power electronic devices and configuration implemented in the multi-wedge motor architecture.

It should be appreciated that the control electronics within each wedge and a control system configured to communicate with the control electronics may be configured to continuously and automatically tune the complex real systems behavior. While, complex real systems are difficult to completely and formally optimize in the field, particularly when unknown variables such as, for example, fuel quality, well pressure and subtle electromechanical changes due to temperature, are constantly changing. The system may be configured to continuously make judiciously chosen, small changes (variations) on controllable variables and to monitor the effect on relevant observable variables. A number of methods and algorithmic approaches may be applied to the system control and machine health management approach embodied in this invention.

For the frack system, the fundamental controllable variables may include turbine fuel and air input flow, alternator field DC current, motor coil average current, the frequency and phase with respect to rotor position, other parameters, or any combination thereof. The relative phase between coils may be fixed by the number of coils for highest efficiency, but may be slightly modified to minimize vibration and noise. In some instances, the pump may have few or no controllable inputs, except valve controls for allowing or closing the fluid flow to discrete cylinders. The frack system fundamental observables may include turbine RPM and torque, alternator output voltage and current, motor torque and RPM, pump flow and pressure, other parameters, or any combination thereof.

In the variational tuning method, a rough and stable desired power operation point for the turbine rpm, alternator voltage, motor RPM and pump flow may be experimentally found and stored in a look up table for a given well pressure. It should be understood that the most fundamental controllable may be the fluid flow and the fundamental observable may be the well pressure. The fundamental system input may be power in the form of fuel flow.

Given that the alternator and motor are very efficient and that the pump efficiency is relatively constant in the short term, the first variables to optimize may include the turbine fuel and air flow since the turbine is at best low 40s% efficient. For a given motor power, the Air-fuel mixture may be varied over a few seconds and the alternator output power can be easily measured. In some embodiments, the most efficient turbine power point might be at a higher rpm, which would be, at a lower alternator field current, for the same alternator/motor DC bus voltage. It can be readily deduced that the alternator field will also need to be varied, over 10 s of seconds or so, to find the optimum combination of fuel/air and rpm for a given power.

At optimum efficiency, system power flow can be proportional to fuel flow, alternator current×voltage, motor rpm×torque, and pump flow x pressure. Only in an integrated MVDC frack fleet system can efficiency be fully optimized because we have control over the key variables. This is not true with an AC system as the turbine, diesel and alternator RPM are all fixed due to the fixed 60 Hz line frequency.

Even though the electric motor and drive electronics may be comparably much more efficient than the prime mover, the motor coil currents may be adjusted to reduce or even minimize the losses in the IGBT, windings, and magnets. This is a much more time intensive optimization, as the relevant observables may include the coil, magnet, and IGBT. The cold plate temperature increases may have much slower time constants. For example, the IGBT switching frequency, current phase, and harmonic current might be varied over 10 s of minutes to minimize a weighted function of the various temperature losses. The temperature of most motors may increase with coil current, harmonic distortion and switching frequency. For a given maximum safe temperature rise, optimizing the coil current wave form may make it possible to optimize maximum available motor torque while intelligently limiting chosen elements to prevent component lifecycle decay.

In practice, the variational method can be applied by using a digital control computer to store the various initial reasonable operating points and then to continuously dither (vary sinusoidal, ramped or triangle wave), within preset bounds and time scales, all the controllable input variables in search of a weighted optimum operating point. It should be noted that non-standard and previously unidentified waveforms may be optimized by the control architecture to fit the specific characteristics of the modular coil as it fits within the system. In some implementations, the waveforms may not even be periodic or regularly geometric, such that the waveform itself may be programmed to provide a selected performance characteristic. Near convergence to the optimal point, the variations can be so small as to not be easily perceptible by local operators. Other embodiments are also possible. Further, in some embodiments, historical data may be processed (in the background, offline, or by high-powered processing systems) to identify parameter adjustments to optimize performance based on historical predictors. Other embodiments are also possible.

Although the present invention has been described with reference to preferred embodiments, workers skilled in the art will recognize that changes may be made in form and detail without departing from the scope of the invention.

What is claimed is:

1. A system comprising:
an electrical motor including:
a cylindrical rotor including an inner circumferential magnetic array and an outer circumferential magnetic array spaced apart by an air gap;
a stator including a circumferential array of coils sized to fit within the air gap; and
a plurality of power electronic circuits, each power electronic circuit of the plurality of power electronic circuits to independently control current to one or more coils of the circumferential array of coils.

2. The system of claim 1, further comprising:
a housing sized to secure the cylindrical rotor and the stator;
wherein at least one of the cylindrical rotor, the stator, or the housing are formed from composite material.

3. The system of claim 1, wherein each coil assembly of the circumferential array of coils comprises:
a laminate core including cooling channels;
a winding about the laminate core; and
a separator structure to secure the laminate core and the winding, the separator structure including:
oil cooling inputs and outputs; and
a plurality of channels to allow cooling oil flow around the winding and the laminate core and through the cooling channels.

4. The system of claim 1, wherein each power electronic circuit controls a set of coils of the circumferential array of coils asynchronously to manage cogging and torque variations.

5. The system of claim 1, wherein each power electronic circuit controls each coil of the set of coils independently of one another such that each coil has an independent time variant output driven by the power electronic circuit.

6. The system of claim 1, wherein:
the stator includes at least a first number of electromagnetic poles; and
the rotor includes a second number of magnetic poles that is greater than the first number.

7. The system of claim 1, wherein the stator and the plurality of power electronics circuits are immersed in oil.

8. The system of claim 1, further comprising:
a second electrical motor coupled to the electrical motor via a common shaft, the second electrical motor including:
a second cylindrical rotor including an inner circumferential magnetic array and an outer circumferential magnetic array spaced apart by an air gap;
a second stator including a second circumferential array of coils sized to fit within the air gap of the second cylindrical rotor; and
a second plurality of power electronic circuits, each power electronic circuit of the second plurality of power electronic circuits to independently control current to one or more coils of the second circumferential array of coils.

9. A motor comprising:
a shaft defining an axis;
a stator including:
a base defining an opening to receive the shaft;
a plurality of electromagnetic coils coupled to the base and arranged to form a ring spaced apart from the opening; and
power electronics circuitry coupled to the base between the opening and the plurality of electromagnetic coils and spaced apart from the plurality of electromagnetic coils, the power electronics circuitry to control each coil of the plurality of electromagnetic coils independently; and
a rotor including an opening to couple to the shaft:
an inner magnetic array arranged in a first circle;
an outer magnetic array arranged in a second circle that is larger than and spaced apart from the first circle defining an air gap sized to receive the plurality of electromagnetic coils.

10. The motor of claim 9, further comprising:
a housing sized to secure the rotor and the stator;
wherein at least one of the rotor, the stator, or the housing includes diamagnetic materials including pyrolytic graphite to assist in structural support, magnetic containment and spreading of localized heating.

11. The motor of claim 9, wherein each coil of the plurality of electromagnetic coils comprises:
a laminate core including cooling channels defined in the laminate core;
a winding about the laminate core; and
a separator structure to secure the laminate core and the winding.

12. The motor of claim 11, wherein the separator structure further comprises:
oil cooling inputs and outputs; and
a plurality of channels to allow cooling oil flow around the winding and the laminate core.

13. The motor of claim 9, wherein the power electronics circuitry includes a plurality of power electronic circuits, each power electronic circuit controls one or more coils of the plurality of electromagnetic coils.

14. The motor of claim 13, wherein the power electronic circuit controls each of the one or more coils independently of one another such that each coil has an independent time variant output driven by the power electronic circuit.

15. The motor of claim 9, wherein the stator and the plurality of power electronics circuits are immersed in oil.

16. A motor comprising:
a rotor including:
a housing coupled to a shaft defining an axis of rotation;
a first magnetic array arranged to form an inner ring within the housing;
a second magnetic array arranged to form an outer ring within the housing and spaced apart from the first magnetic array by an air gap;
a stator including:
a base defining an opening sized to fit over the shaft;
a plurality of electromagnetic coils coupled to the base and arranged to form a ring such that the ring fits within the air gap; and
a plurality of power electronic circuits coupled to the base, spaced apart from the plurality of electromagnetic coils, and positioned between the plurality of electromagnetic coils and the opening, each of the plurality of power electronic circuits to control one or more of the coils of the plurality of electromagnetic coils.

17. The motor of claim 16, wherein the power electronic circuit controls each of the one or more coils independently of one another such that each coil has an independent time variant output driven by the power electronic circuit.

18. The motor of claim 16, wherein at least one of the rotor, the stator, or the housing includes diamagnetic materials including pyrolytic graphite to assist in structural support, magnetic containment and spreading of localized heating.

19. The motor of claim 16, wherein each coil of the plurality of electromagnetic coils comprises:
a laminate core including cooling channels;
a winding about the laminate core; and
a separator structure to secure the laminate core and the winding.

20. The motor of claim 19, wherein the separator structure further comprises:
oil cooling inputs and outputs; and
a plurality of channels to allow cooling oil flow around the winding and the laminate core and through the cooling channels.
